(19) United States
(12) Patent Application Publication
(10) Pub. No.: US 2012/0105509 A1
(43) Pub. Date: May 3, 2012

(54) IMAGE DISPLAY DEVICE, CONTROL DEVICE FOR SAME, AND INTEGRATED CIRCUIT

(75) Inventors: Takeshi Ito, Osaka (JP); Haruo Yamashita, Osaka (JP)

(73) Assignee: PANASONIC CORPORATION, Osaka (JP)

(21) Appl. No.: 13/381,625

(22) PCT Filed: Jun. 30, 2010
(86) PCT No.: PCT/JP2010/004305

§ 371 Date: Dec. 29, 2011

(30) Foreign Application Priority Data
Jul. 1, 2009 (JP) 2009-156693

(51) Int. Cl. G09G 5/10

(52) U.S. Cl. 345/690

(57) ABSTRACT

Disclosed is an image display device having improved image qualities, while reducing power consumption. A backlight unit (20) includes a plurality of light sources disposed so as to form a plurality of light emission regions. A liquid crystal panel (10) displays an image by modulating light emitted from the backlight unit (20) in accordance with light emission transmissivity. A control unit (40) controls the light emission luminance value of the backlight unit (20) for each light emission region, and controls a liquid crystal display device (1). The control unit (40) calculates the light emission transmissivity, on the basis of the distances between the pixels of the liquid crystal panel (10) and the reference position(s) in one or more light emission regions, the luminance value of light that arrives the pixels, said luminance value being determined on the basis of the controlled light emission luminance value, and the image signals inputted to the pixels.

### TECHNICAL FIELD

The present invention relates to an image display apparatus, control apparatus therefor, and integrated circuit.

### BACKGROUND ART

In recent years, liquid crystal display apparatuses capable of displaying still-image or moving-image video have rapidly increased in popularity as prices have fallen due to advances in manufacturing technology, and liquid crystal display apparatuses themselves have become slimmer and lighter at the same time as higher image quality technologies have been developed for display functions. Liquid crystal display apparatuses are widely used in personal computer (PC) monitors, digital TVs that receive and display digital broadcast waves, and so forth.

Liquid crystal display apparatuses such as described above are mainly reflective liquid crystal display apparatuses or transmissive liquid crystal display apparatuses. Of these two types, transmissive liquid crystal display apparatuses are generally more widely used. Such a transmissive liquid crystal display apparatus is provided with a planar light source called a backlight comprising a cold-cathode tube, for example, and performs display of a desired image by spatial modulation of light emitted therefrom in a liquid crystal panel.

With a conventional liquid crystal display apparatus such as described above, if a desired image is a dark image, for example, the dark image is represented by adjusting the transmissivity of light in the liquid crystal panel, and backlight luminance adjustment is not performed. Consequently, there is a problem in that, even with a dark image of this kind, the backlight emits light at maximum luminance, and therefore power consumption is high. Moreover, since the transmissivity of liquid crystal panel light never becomes absolutely 0, light from the backlight leaks even into an image of a dark scene, and a so-called “floating black” phenomenon occurs that gives a whitish image display.

As a countermeasure to this, technologies have been proposed whereby a screen is divided using LEDs or suchlike light sources, and backlight luminance is varied locally. In Patent Literature 1, a technology is disclosed whereby a quantity of light from a light source of another area within an area is treated as constant. In Patent Literature 2, a configuration is described whereby a luminance distribution between backlight areas is found using an approximation function. And in Patent Literature 3, performing tone correction according to the luminance level of a light source of another area is disclosed.

### CITATION LIST

### Patent Literature

PTL 1

Japanese Patent Application Laid-Open No. 2007-034251

PTL 2

Japanese Patent Application Laid-Open No. 2005-258403

PTL 3

Japanese Patent Application Laid-Open No. 2002-99250

### SUMMARY OF INVENTION

### Technical Problem

When a technology is implemented whereby a screen is divided using light emitting diodes (LEDs) or suchlike light sources, and backlight luminance is varied locally, control to keep displayed luminance equal to an image signal cannot be performed unless the light emission luminance value of each pixel is known. Moreover, the light emission luminance value of each pixel cannot be known unless a quantity of light coming from a light source of another area is considered for each pixel.

It is an object of the present invention to provide an image display apparatus, control apparatus therefor, and integrated circuit that enable a reduction in power consumption to be achieved while displaying a high-quality image.

### Solution to Problem

An image display apparatus of the present invention is provided with: a light source section including a plurality of light sources arranged so that a plurality of light emission areas are formed; a display section that displays an image by modulating light from the light source section in accordance with a modulation coefficient corresponding to an input image signal; a light source control section that controls a light emission luminance value of the light source section for each light emission area; and a control section that controls the image display apparatus; wherein the control section, based on distance information indicating the distance between a pixel of the display section and a reference position in each of one or more light emission areas, a luminance value of light arriving at the pixel decided based on a controlled light emission luminance value, and an input image signal of the pixel, calculates the modulation coefficient corresponding to an input image signal of the pixel.

A control apparatus of the present invention is a control apparatus that performs control of an image display apparatus that displays an image by modulating, in accordance with a modulation coefficient corresponding to an input image signal, light from a light source section that includes a plurality of light sources arranged so that a plurality of light emission areas are formed and for which a light emission luminance value is controlled for each light emission area; this control apparatus being provided with a control section that, based on distance information indicating the distance between a pixel and a reference position in each of one or more light emission areas, a luminance value of light arriving at the pixel decided based on a controlled light emission luminance value, and an input image signal of the pixel, calculates the modulation coefficient corresponding to an input image signal of the pixel.

An integrated circuit of the present invention is an integrated circuit that performs control of an image display apparatus; wherein: the image display apparatus is provided with a light source section including a plurality of light sources arranged so that a plurality of light emission areas are formed, and a display section that displays an image by modulating light from the light source section in accordance with a modulation coefficient corresponding to an input image signal; the integrated circuit is provided with a light source control section that controls a light emission luminance value of the light source section for each light emission area, and a control section that controls the image display apparatus; and the control section, based on distance information indicating the distance between a pixel of the display section and a reference position in each of one or more light emission areas, a luminance value of light arriving at the pixel decided based on a controlled light emission luminance value, and an input image signal of the pixel, calculates the modulation coefficient corresponding to an input image signal of the pixel.

### ADVANTAGEOUS EFFECTS OF INVENTION

The present invention enables a reduction in power consumption to be achieved while displaying a high-quality image.

### BRIEF DESCRIPTION OF DRAWINGS

FIG. 1 is a schematic diagram showing a liquid crystal display apparatus according to Embodiment 1 of the present invention;

FIG. 2 is a drawing showing an actual configuration of a backlight section according to Embodiment 1 of the present invention;

FIG. 3 is a schematic diagram showing an actual configuration of a control section according to Embodiment 1 of the present invention;

FIG. 4 is a schematic diagram showing an actual configuration of a luminance estimation section according to Embodiment 1 of the present invention;

FIG. 5 is a drawing showing the relationship between a backlight section and virtual light sources according to Embodiment 1 of the present invention;

FIG. 6 is a drawing for explaining calculation of distance information according to Embodiment 1 of the present invention;

FIG. 7 is a schematic diagram showing an actual configuration of a luminance calculation section according to Embodiment 1 of the present invention;

FIG. 8 is a drawing showing a light emission characteristic of a virtual light source according to Embodiment 1 of the present invention;

FIG. 9 is a drawing showing an example of an image signal input to a liquid crystal display apparatus according to Embodiment 1 of the present invention;

FIG. 10 is a drawing showing transmissivity for each pixel of an image signal input to a liquid crystal display apparatus according to Embodiment 1 of the present invention;

FIG. 11 is a drawing showing luminance signals generated based on an image signal input to a liquid crystal display apparatus according to Embodiment 1 of the present invention;

FIG. 12 is a drawing showing an estimated light emission luminance value of each pixel based on distance information input from a distance calculation section according to Embodiment 1 of the present invention;

FIG. 13 is a drawing showing transmissivities generated by an image correction section according to Embodiment 1 of the present invention;

FIG. 14 is a schematic diagram showing a configuration of a luminance estimation section according to Embodiment 2 of the present invention;

FIG. 15 is a drawing for explaining calculation of angle information according to Embodiment 2 of the present invention;

FIG. 16 is a drawing showing the relationship between angle information and a distance information correction coefficient according to Embodiment 2 of the present invention;

FIG. 17 is a drawing for explaining an operation correcting a luminance profile by means of angle information according to Embodiment 2 of the present invention;

FIG. 18 is a schematic diagram showing the configuration of a luminance estimation section according to Embodiment 3 of the present invention;

FIG. 19 is a drawing showing a horizontal-direction light emission characteristic of a virtual light source according to Embodiment 3 of the present invention;

FIG. 20 is a drawing showing a vertical-direction light emission characteristic of a virtual light source according to Embodiment 3 of the present invention;

FIG. 21 is a drawing showing one light emission area according to Embodiment 3 of the present invention;

FIG. 22 is a drawing showing a post-combining normalized luminance distribution according to Embodiment 3 of the present invention;

FIG. 23 is a drawing for explaining a method of generating distance information using an elliptical characteristic according to Embodiment 4 of the present invention;

FIG. 24 is a drawing showing the relationship between ellipticity and distance information according to Embodiment 4 of the present invention;

FIG. 25 is a drawing showing a configuration in which a backlight section is provided with a reflector according to another embodiment of the present invention;

FIG. 26 is a drawing showing a configuration of a control section that can control a backlight independently for R, G, and B according to another embodiment of the present invention;

FIG. 27 is a drawing showing an example of an unequal pitch array of light sources according to another embodiment of the present invention;

FIG. 28 is a drawing showing another example of an unequal pitch array of light sources according to another embodiment of the present invention; and

FIG. 29 is a drawing showing an example of a delta array of light sources according to another embodiment of the present invention.

### DESCRIPTION OF EMBODIMENTS

Now, embodiments of the present invention will be described with reference to the accompanying drawings.

### Embodiment 1

Embodiment 1 is described below with reference to the accompanying drawings.

<1-1. Configuration of Liquid Crystal Display Apparatus>

First, the configuration of a liquid crystal display apparatus will be described.

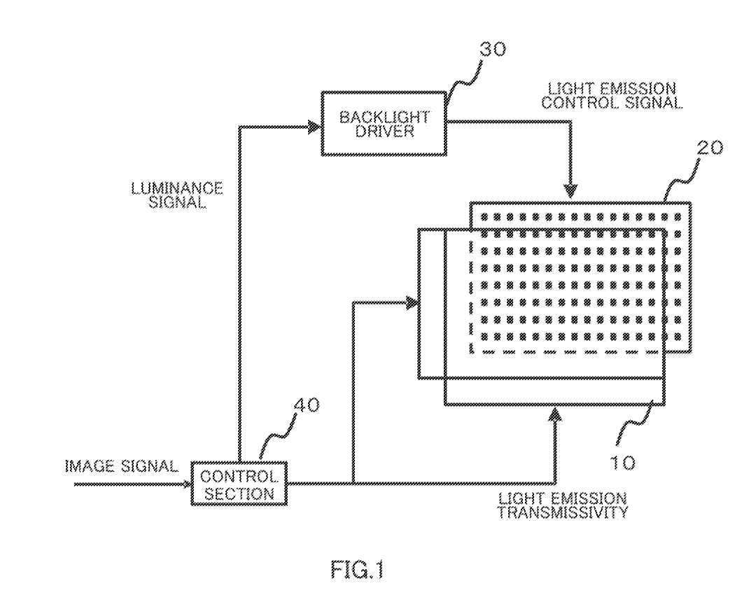

FIG. 1 is a schematic diagram showing a liquid crystal display apparatus according to Embodiment 1 of the present invention.

The liquid crystal display apparatus has liquid crystal panel 10, backlight section 20, backlight driver 30, and control section 40. The configuration of each section will now be described in detail.

<1-1-1. Liquid Crystal Panel>

Liquid crystal panel 10 functioning as a display section displays an image by modulating irradiation light radiated from the rear surface by backlight section 20 according to a control signal input from control section 40.

Liquid crystal panel 10 has a configuration comprising a liquid crystal layer on a glass substrate, and transmissivity is controlled by a signal voltage being provided to a liquid crystal layer corresponding to each pixel by means of a gate driver (not shown) and a source driver (not shown) and so forth. Liquid crystal panel 10 is configured so that control signals are provided to a liquid crystal panel 10 gate driver and source driver from control section 40.

Liquid crystal panel 10 uses an IPS (In Plane Switching) method. A feature of IPS is that there is little color tone variation due to the viewing direction and color variation of all tones over a wide viewing angle due to a simple movement of rotation of liquid crystal molecules parallel to the glass substrate.

Liquid crystal panel 10 may be any kind of device that performs optical modulation, and may use VA (Vertical Alignment) or the like as another optical modulation method, for example.

That is to say, liquid crystal panel 10 is one kind of non-light-emitting display device, and a different kind of non-light-emitting display device can be substituted as a display section of the present invention. Therefore, an image display apparatus of the present invention is not limited to a liquid crystal display apparatus. Also, since transmissivity is an optical modulation coefficient determined in correspondence to an image signal of each pixel used when a display device is a liquid crystal panel, a different optical modulation coefficient can be used when the display device used is not a liquid crystal panel.

<1-1-2. Backlight Section>

Backlight section 20 functioning as a light source section is a device that irradiates the rear surface of liquid crystal panel 10 with irradiation light for displaying an image.

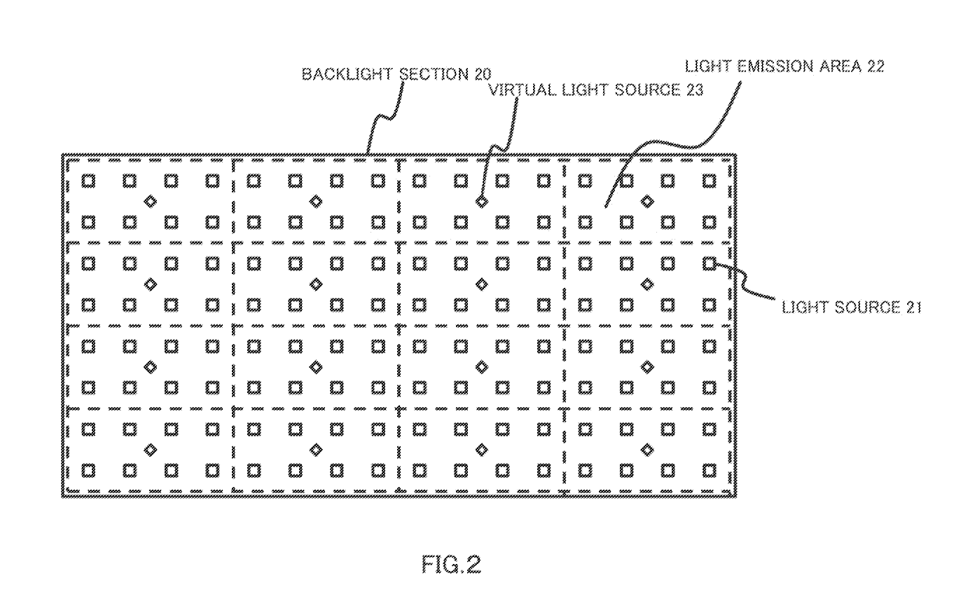

Backlight section 20 has a plurality of light sources 21 (FIG. 2). Backlight section 20 controls a light emission area with at least one or more light sources 21 as a unit as a basic unit based on a light emission control signal output from backlight driver 30. Respective light emission areas are provided opposite a screen display area of liquid crystal panel 10, and mainly irradiate an opposite screen display area. Here, the phrase “mainly irradiate” is used since some illumination light may also irradiate a screen display area that is not opposite.

A diffusion sheet may also be provided between liquid crystal panel 10 and backlight section 20 for the purpose of making the light irradiated from a light emission area uniform.

Here, light source 21 uses an LED emitting white light. Light source 21 is not limited to a device that emits white light directly. For example, light source 21 may also be a device that emits white light by mixing R, G, and B light. Also, a different kind of light source (for example, a semiconductor laser light source or organic EL (Electroluminescence) light source or the like) may be used instead of an LED.

FIG. 2 is a drawing showing an actual configuration of backlight section 20.

Backlight section 20 is a so-called directly-below backlight apparatus characterized by having a plurality of light sources 21 arranged evenly on a surface opposite the rear surface of liquid crystal panel 10. Backlight section 20 is provided with light emission areas 22 having eight light sources 21 as one unit. These light sources 21 are configured with the provision of a diffuser so that light emission area 22 emits light uniformly. Furthermore, light emission area 22 has virtual light source 23 set so that eight light sources 21 are handled virtually as one light source. Virtual light source 23 is set in a reference position within a light emission area. As shown in FIG. 2, backlight section 20 comprises 16 light emission areas.

Control section 40 controls light emission area 22 by controlling this virtual light source 23. The placement position of virtual light source 23—that is, the reference position within light emission area 22—is the center part of light emission area 22 in the example shown in FIG. 2, but when eight light sources 21 are controlled simultaneously, any arrangement may be used whereby uniform light emission is possible for light emission area 22. Depending on the degree of diffusion of each light source 21 or the arrangement of light sources 21, a position deviating from the center of light emission area 22 may be a reference position within light emission area 22.

<1-1-3. Backlight Driver>

Backlight driver 30 generates a light emission control signal based on a luminance signal in which luminescence is set for each light emission area, input from control section 40. Backlight driver 30 outputs a generated light emission control signal to backlight section 20. A light emission control signal is a signal for controlling driving of each light source 21. Backlight driver 30 can be implemented by means of an electrical circuit or the like.

<1-1-4. Control Section>

Control section 40 generates light emission transmissivity stipulating transmissivity of a liquid crystal layer corresponding to each pixel of liquid crystal panel 10 based on an input image signal. Furthermore, control section 40 generates a luminance signal stipulating luminescence for each of a plurality of light emission areas of backlight section 20. Control section 40 is implemented by a combination of a computational processing apparatus (for example, a CPU (Central Processing Unit)) and a storage apparatus, and configures a control apparatus of the present invention.

In this embodiment, since backlight section 20 is divided into 16 as shown in FIG. 2, control section 40 generates 16 luminance signals for one frame of an input signal.

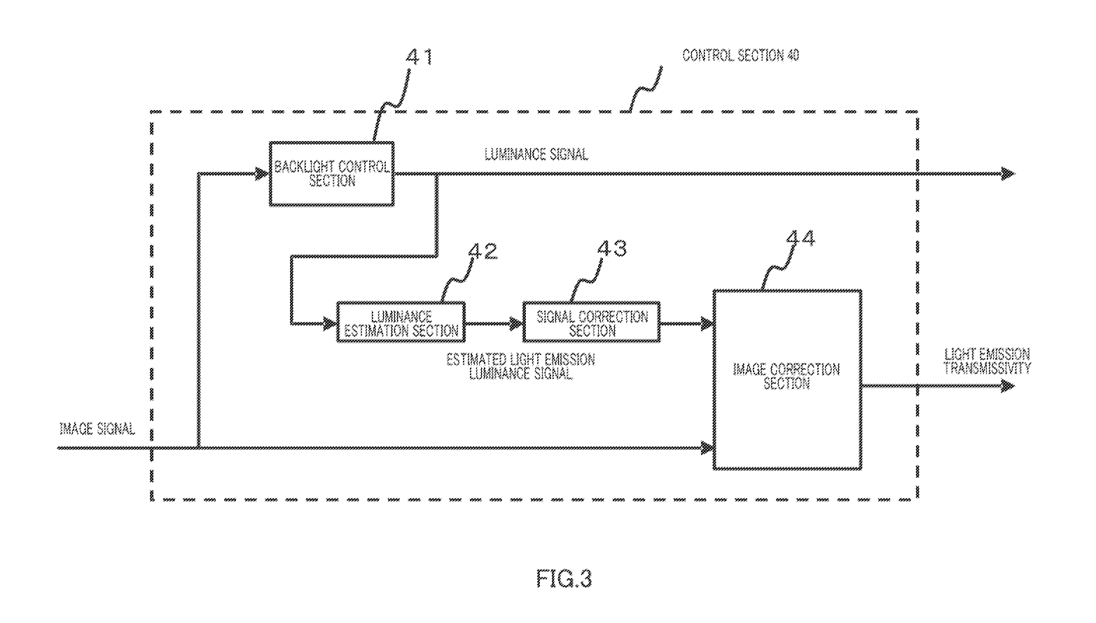

FIG. 3 is a schematic diagram showing an actual configuration of control section 40.

Specifically, control section 40 has backlight control section 41, luminance estimation section 42, signal correction section 43, and image correction section 44.

<1-1-4-1. Backlight Control Section>

Backlight control section 41 functioning as a light source control section generates a luminance signal based on an input image signal. Backlight control section 41 outputs a generated luminance signal to backlight driver 30 and luminance estimation section 42.

A luminance signal according to this embodiment is a signal that decides the luminescence of each virtual light source 23, and indicates a proportion of light emission luminance relative to the maximum luminance value of each virtual light source 23. For convenience of explanation, a proportion when virtual light source 23 non-light-emission luminance is set to 0, maximum luminance is set to 255, and the relevant maximum luminance 255 is set to 1 is assumed to be a luminance signal. For example, if light emission luminance is 128, a luminance signal is 0.5.

<1-1-4-2. Luminance Estimation Section>

Luminance estimation section 42 generates an estimated light emission luminance signal indicating an estimated value of display luminance (hereinafter referred to as “estimated light emission luminance value”) of each pixel of liquid crystal panel 10 based on a luminance signal input from backlight control section 41. Luminance estimation section 42 outputs an estimated light emission luminance signal to signal correction section 43.

An actual configuration of luminance estimation section 42 will now be described with reference to the accompanying drawings.

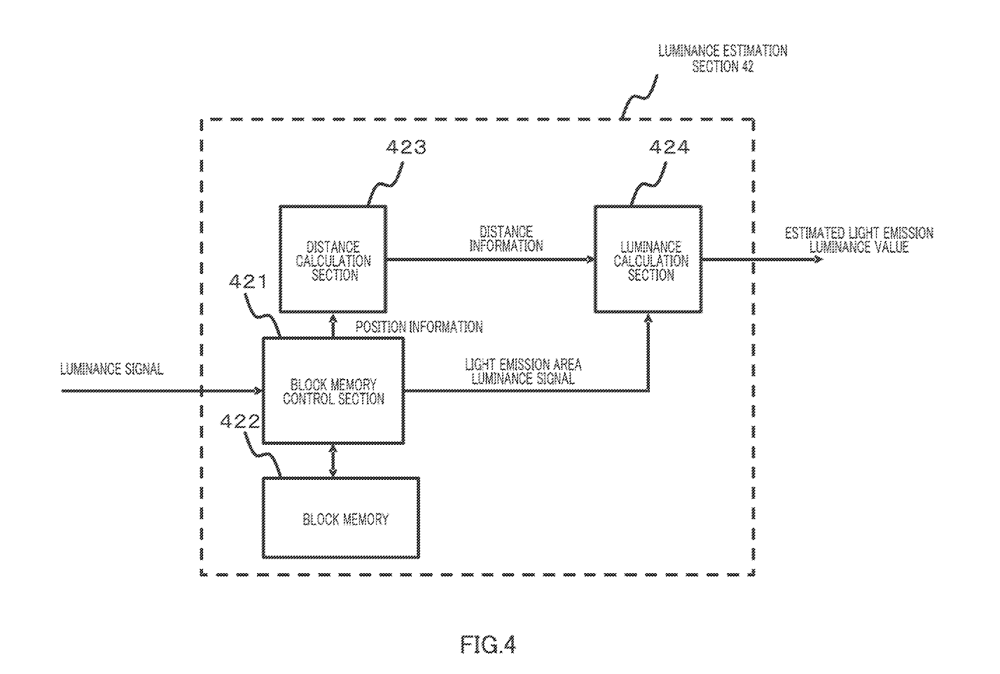

FIG. 4 is a schematic diagram showing an actual configuration of luminance estimation section 42.

Luminance estimation section 42 has block memory control section 421, block memory 422, distance calculation section 423, and luminance calculation section 424.

<1-1-4-2-1. Block Memory Control Section>

Block memory control section 421 performs reading and writing of information stored in block memory 422, and also outputs information read from block memory 422 to distance calculation section 423 and luminance calculation section 424.

When a luminance signal is actually input from backlight control section 41, block memory control section 421 stores an input luminance signal in block memory 422. When performing luminance signal storage in block memory 422, block memory control section 421 may perform control so that luminance signals for all light emission areas of backlight section 20 are stored. Alternatively, block memory control section 421 may perform control so that only a luminance signal relating to processing by distance calculation section 423 is stored. In the case of block memory control section 421 according to this embodiment, a configuration is described whereby luminance signals for all light emission areas of backlight section 20 are stored.

Block memory control section 421 also stores virtual light source 23 position coordinates in a backlight section 20 area in block memory 432, and outputs virtual light source 23 position coordinates to distance calculation section 423.

Furthermore, of the luminance signals stored in block memory 422, block memory control section 421 outputs a luminance signal considered to be necessary for processing by luminance calculation section 424 to luminance calculation section 424.

<1-1-4-2-2. Block Memory>

Block memory 422 stores luminance signals and virtual light source 23 position coordinates. Virtual light source 23 position coordinates are values set at the time of backlight section 20 design, and are assumed to be stored beforehand by the manufacturer.

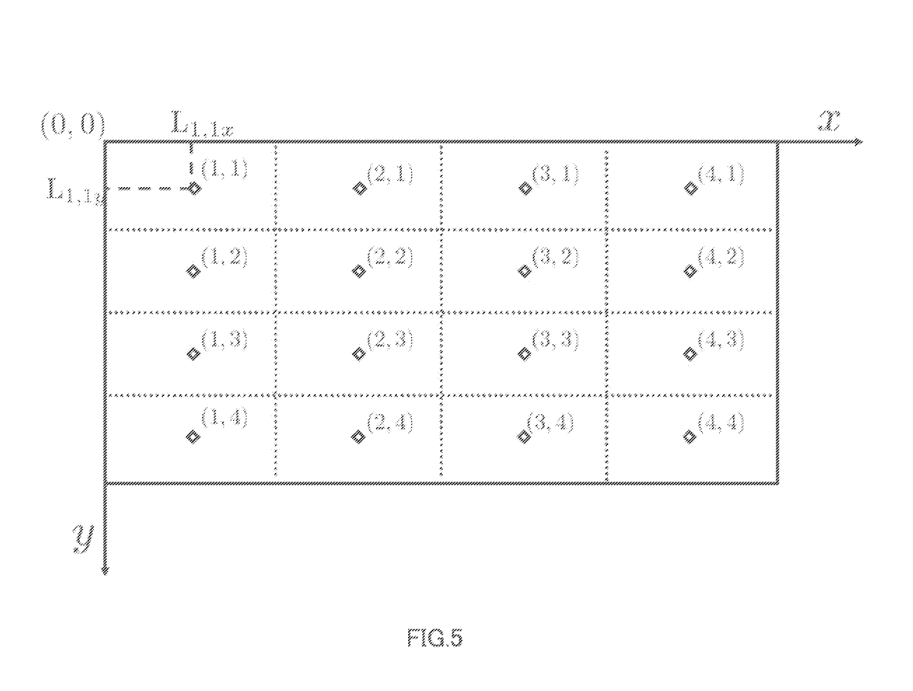

FIG. 5 is a drawing showing the relationship between backlight section 20 and virtual light sources 23 in backlight section 20.

In this embodiment, when backlight section 20 is arranged in a transverse plane as shown in FIG. 5, the top-left part is set as the origin (0,0). Also, it is assumed that numbers from (1,1) to (4,4) are assigned according to the positions of virtual light sources 23 in backlight section 20. It is thus assumed that position coordinates for these numbers are set as shown in equation 1.

[symbol]

_{(i,j)=(}L_{i,jx}L_{i,jy}) . . . where . . . i, j ε{1, 2, 3, 4}

Virtual light source 23 position coordinate setting is not limited to the above method, and any kind of setting method may be used that enables the positions of virtual light sources 23 in backlight section 20 to be uniquely identified.

The x-axis direction and y-axis direction shown in FIG. 5 correspond respectively to the horizontal direction and vertical direction on the display screen of liquid crystal panel 10, and therefore in the following description the x-axis direction is referred to as the horizontal direction, and the y-axis direction as the vertical direction.

<1-1-4-2-3. Distance Calculation Section>

Distance calculation section 423 generates distance information indicating distances between a pixel and each virtual light source 23 in liquid crystal panel 10. Then distance calculation section 423 outputs generated distance information to luminance calculation section 424. Below, a pixel subject to processing by control section 40 and so forth is referred to as a pixel of interest.

In this embodiment, distance calculation section 423 calculates distance information D indicating distances between a pixel of interest and all virtual light sources 23 set in backlight section 20. After once calculating distance information D for a certain pixel, distance calculation section 423 may hold that calculation result so that it is not necessary to perform repeated calculation of distance information D for that pixel.

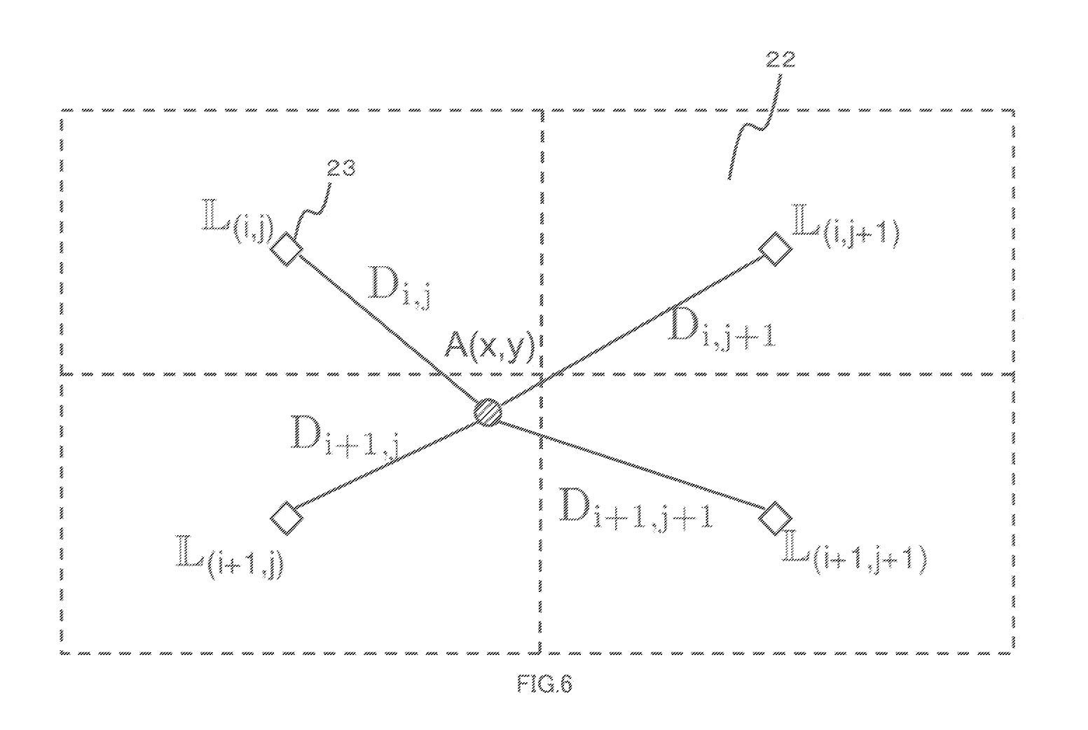

FIG. 6 is a drawing for explaining calculation of distance information D by distance calculation section 423.

For example, consider finding distance information D_{i,j} for the distance between pixel A and virtual light source L_{(i,j)}. The position coordinates of pixel A can be acquired as (x,y). In this case, distance information Di,j can be calculated by means of equation 2.

D_{i,j}=✓\sqrt{(L_{i,jx}−x)²+(L_{i,jy}−y)²}

Distance calculation section 423 calculates distances from virtual light sources L(i,j), . . . L(i+4,j+4) in backlight section 20 as distance information D for pixel A, and outputs distance information D represented in the form of equation 3 to luminance calculation section 424. Here, i and j are assumed to be natural numbers from 1 to 4, since a virtual light source L matrix in this embodiment is 4×4.

In the above description, only distance information D for pixel A has been described, but the same kind of distance information calculation is performed for all pixels in liquid crystal panel 10. That is to say, if liquid crystal panel 10 has 2 million pixels, 2 million sets of distance information D represented in the form of equation 3 are output to luminance calculation section 424.

$$𝔻 = [ \begin{matrix}{D}_{1 , 1} & {D}_{1 , 2} & … & {D}_{1 , 4} \\ {D}_{2 , 1} & {D}_{2 , 2} & … & {D}_{2 , 4} \\ ⋮ & ⋮ & ⋱ & ⋮ \\ {D}_{4 , 1} & {D}_{4 , 2} & … & {D}_{4 , 4}\end{matrix} ] \qquad [ 3 ]$$

In this embodiment, when generating distance information D for pixels of interest and virtual light sources 23, a configuration is assumed whereby distances from all virtual light sources 23 are found. However, provision may also be made, for example, for only distances from n (where n is a positive integer) nearby virtual light sources 23 to be found, or for only the distance from the nearest single virtual light source 23 to be found. Also, the format of distance information output from distance calculation section 423 to luminance calculation section 424 is not limited to that represented by equation 3.

<1-1-4-2-4. Luminance Calculation Section>

Luminance calculation section 424 generates an estimated light emission luminance value of light arriving at a pixel of interest based on distance information D output from distance calculation section 423 and a luminance signal of a light emission area that includes the pixel of interest output from block memory control section 421. Luminance calculation section 424 outputs a generated estimated light emission luminance value to signal correction section 43.

An actual configuration of luminance calculation section 424 will now be described with reference to the accompanying drawings.

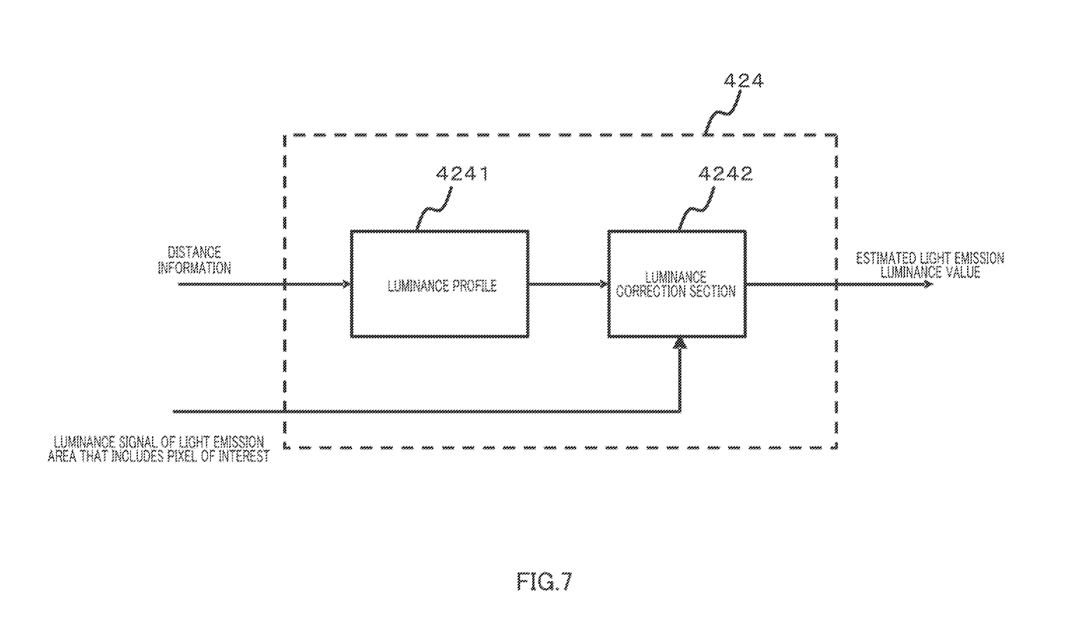

FIG. 7 is a schematic diagram showing an actual configuration of luminance calculation section 424.

Luminance calculation section 424 has luminance profile 4241 and luminance correction section 4242.

<1-1-4-2-4-1. Luminance Profile>

Luminance profile 4241 calculates normalized luminance value N of a pixel for which distance information D has been calculated, based on input distance information D. Normalized luminance value N is represented by equation 4. Furthermore, luminance profile 4241 outputs calculated normalized luminance value N to luminance correction section 4242. Normalized luminance value N is a value indicating luminescence when light is emitted at 100% luminescence for virtual light source 23, and is a value that varies within a range of 0 to 1 according to the distance from virtual light source 23.

$$ℕ = [ \begin{matrix}{N}_{1 , 1} & {N}_{1 , 2} & … & {N}_{1 , 4} \\ {N}_{2 , 1} & {N}_{2 , 2} & … & {N}_{2 , 4} \\ ⋮ & ⋮ & ⋱ & ⋮ \\ {N}_{4 , 1} & {N}_{4 , 2} & … & {N}_{4 , 4}\end{matrix} ] \qquad [ 4 ]$$

The calculation of normalized luminance value N will now be described.

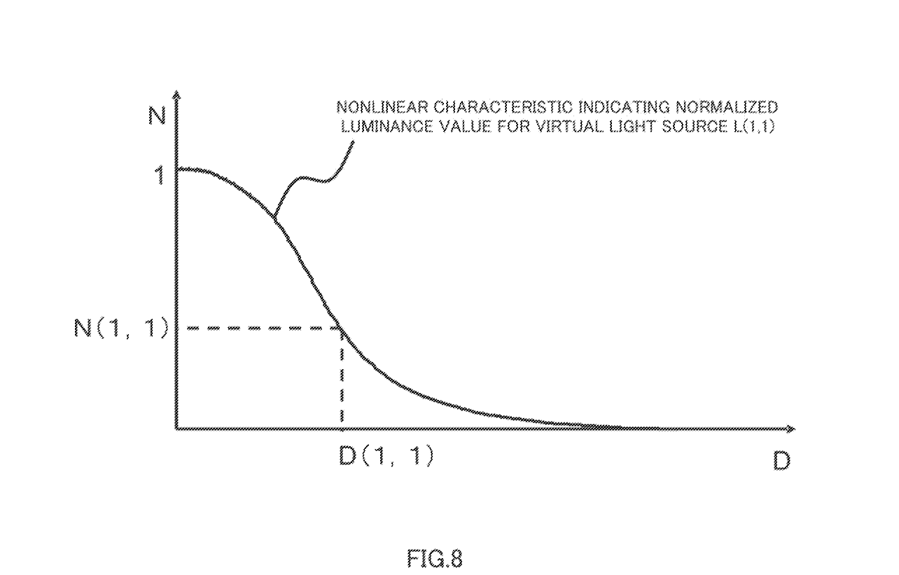

FIG. 8 is a drawing showing a light emission characteristic of virtual light source 23.

Normalized luminance value N of each virtual light source 23 varies according to the degree of diffusion of light of each light source 21, the arrangement method of light sources 21, and the number of light sources 21 included in light emission area 22. The characteristic shown in FIG. 8 shows that the normalized luminance value varies nonlinearly according to the distance from virtual light source L(1,1).

Luminance profile 4241 has the kind of light emission characteristic shown in FIG. 8 as a one-dimensional LUT (Look Up Table). In the LUT, for example, normalized luminance value N derived by means of a nonlinear function having distance information D such as shown in FIG. 8 as an argument is stipulated. In this case, in order to find normalized luminance value N(1,1) for a certain pixel, an LUT set for virtual light source L(1,1) is used to find normalized luminance value N(1,1) from distance information D(1,1) for that pixel and virtual light source L(1,1). Using an LUT enables the processing load to be reduced compared with a case in which a function computation is actually performed.

In luminance profile 4241, the kind of light emission characteristic shown in FIG. 8 is stipulated for each of the 16 light emission areas set in backlight section 20. A different light emission characteristic may be set for each virtual light source 23, or the same light emission characteristic may be set for all virtual light sources 23. If actual light emission characteristics differ between different light emission areas, estimation accuracy can be improved by stipulating light emission characteristics represented by different functions for those light emission areas.

Luminance profile 4241 may use an approximation function such as a polynomial having the kind of characteristic shown in schematic diagram 8, or a configuration may be used whereby only a number of normalized luminance values at representative distances are held as an LUT, and normalized luminance is found by means of known interpolation processing.

Furthermore, since light emission area 22 is divided into 16. luminance profile 4241 finds 16 normalized luminance values (N(1,1) to N(4,4)) for one pixel. In order to reduce the CPU processing load, a configuration may be used whereby distance information D is calculated only for virtual light source 23 within a light emission area that includes a pixel.

<1-1-4-2-4-2. Luminance Correction Section>

Luminance correction section 4242 corrects normalized luminance value N for a pixel of interest output from luminance profile 4241, based on a luminance signal in which luminescence of a light emission area is stipulated. Then luminance correction section 4242 generates an estimated light emission luminance value of light arriving at that pixel. Furthermore, luminance correction section 4242 outputs a generated estimated light emission luminance value to signal correction section 43.

When luminance signal S generated by backlight control section 41 is provided by means of equation 5, luminance correction section 4242 calculates an estimated light emission luminance value for a pixel of interest based on equation 6.

$$𝕊 = [ \begin{matrix}{S}_{1 , 1} & {S}_{1 , 2} & … & {S}_{1 , 4} \\ {S}_{2 , 1} & {S}_{2 , 2} & … & {S}_{2 , 4} \\ ⋮ & ⋮ & ⋱ & ⋮ \\ {S}_{4 , 1} & {S}_{4 , 2} & … & {S}_{4 , 4}\end{matrix} ] \qquad [ 5 ]$$

$$\tilde{L} = {\sum }_{i = 1}^{4} {\sum }_{j = 1}^{4} ( {N}_{i , j} {S}_{i , j} ) \qquad [ 6 ]$$

where L (tilde L) is an estimated light emission luminance value.

<1-1-4-3. Signal Correction Section>

Signal correction section 43 detects a characteristic of an input image signal, and performs characteristic conversion of an estimated light emission luminance value estimated by luminance estimation section 42 in line with the image signal characteristic. For example, if an input image signal has undergone gamma conversion, gamma conversion is executed on an estimated light emission luminance value. A conversion table may be used as the actual conversion method.

<1-1-4-4. Image Correction Section>

Based on an estimated light emission luminance value of a pixel of interest in liquid crystal panel 10 output from signal correction section 43, and transmissivity of a pixel of interest that an input image signal has, image correction section 44 corrects that transmissivity and outputs the corrected transmissivity.

When luminance control is performed for each light emission area in backlight section 20, even if signals input to liquid crystal panel 10 and backlight section 20 have been generated based on the same image signal, a difference in display image luminance difference may occur in line with a difference in luminance of a light emission area that illuminates the display area of that image. Consequently, a displayed image may look unnatural. This problem is due to the fact that an input image signal is generated on the assumption that all light sources in backlight section 20 are constant.

Image correction section 44 corrects transmissivity of a pixel stipulated by an image signal so that a light emission luminance value for an image displayed on liquid crystal panel 10 is changed in line with an estimated light emission luminance value for that pixel generated from a light emission area luminance signal. This correction eliminates the kind of unnaturalness of an image due to display image luminance differences described above, enabling high-quality image display to be achieved.

Here, transmissivity T for a pixel of interest has a relationship represented by dividing display luminance value Y for the pixel of interest by light emission luminance value L as shown in equation 7, for example.

$$T = \frac{Y}{L} \qquad [ 7 ]$$

In a situation in which a light emission area luminance signal varies, in order to make a display luminance value for a pixel constant it is necessary to correct pixel transmissivity in liquid crystal panel 10. Thus, image correction section 44 corrects transmissivity based on equation 7, for example, using estimated light emission luminance value tilde L output from signal correction section 43 as light emission luminance value L.

Image correction section 44 corrects transmissivity for R, G, and B signals included in an image signal.

<1-2. Operation of Liquid Crystal Display Apparatus>

An actual example of display operation of a liquid crystal display apparatus based on the above configuration will now be described with reference to the accompanying drawings.

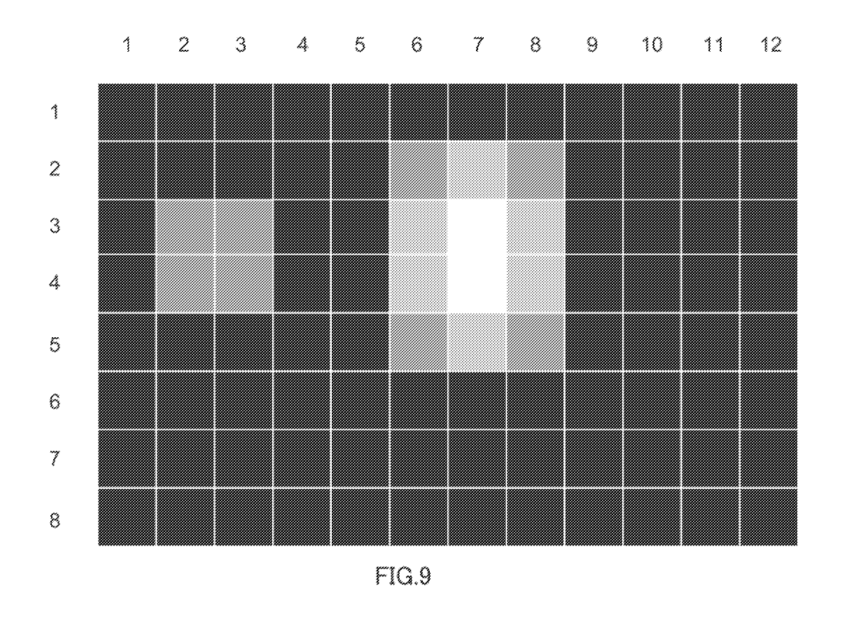

FIG. 9 is a drawing showing an example of an image signal input to a liquid crystal display apparatus. A minimum of two rectangular patterns are arranged on a black background. The white grid lines in FIG. 9 indicate liquid crystal panel 10 pixel frames, and arc not included in an actual image.

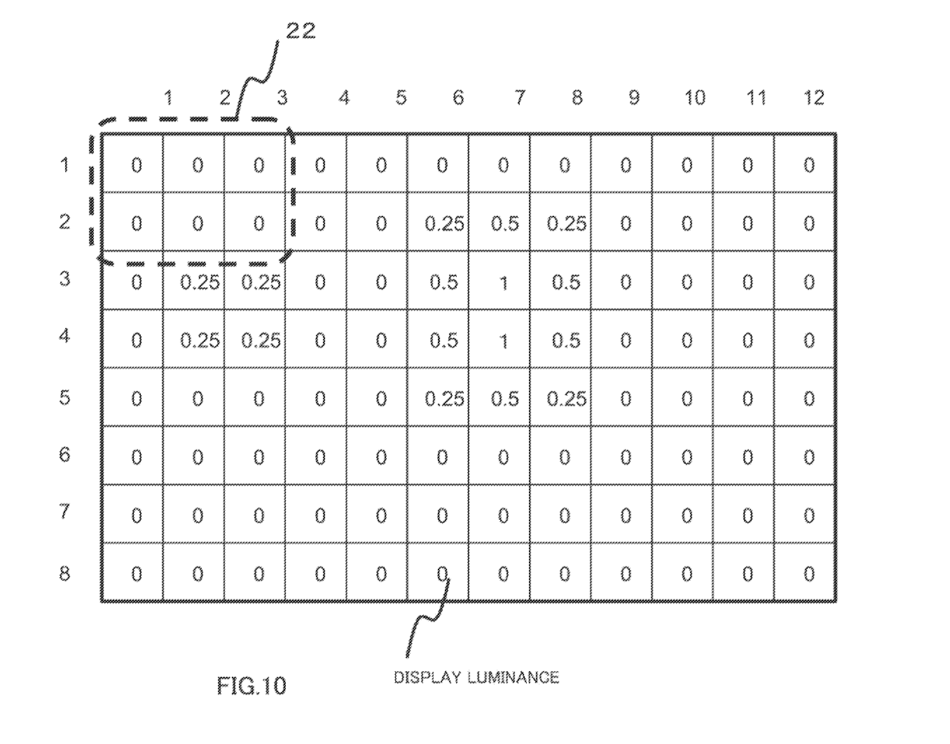

The rectangular patterns shown in FIG. 9 are assumed to have the individual pixel transmissivities shown in FIG. 10. In the rectangular patterns represented in FIG. 9, the luminance of the row-3/column-7 and row-4/column-7 pixels is highest, and luminance decreases progressively around these pixels. Here, it is assumed that 1 is set as image signal transmissivity for maximum light emission luminance 255, and 0 is set for non-light-emission state 0.

In this description of an operation example, a 2-row/3-column area in FIG. 10 is set as one light emission area 22. Also, virtual light source 23 is set as being located in the vicinity of the center of the relevant light emission area 22.

<1-2-1. Light Emission Operation of Backlight Section>

First, the transmissivities shown in FIG. 9 are input to backlight control section 41, and luminance signals stipulating luminescence for each of the plurality of light emission areas of backlight section 20 are generated.

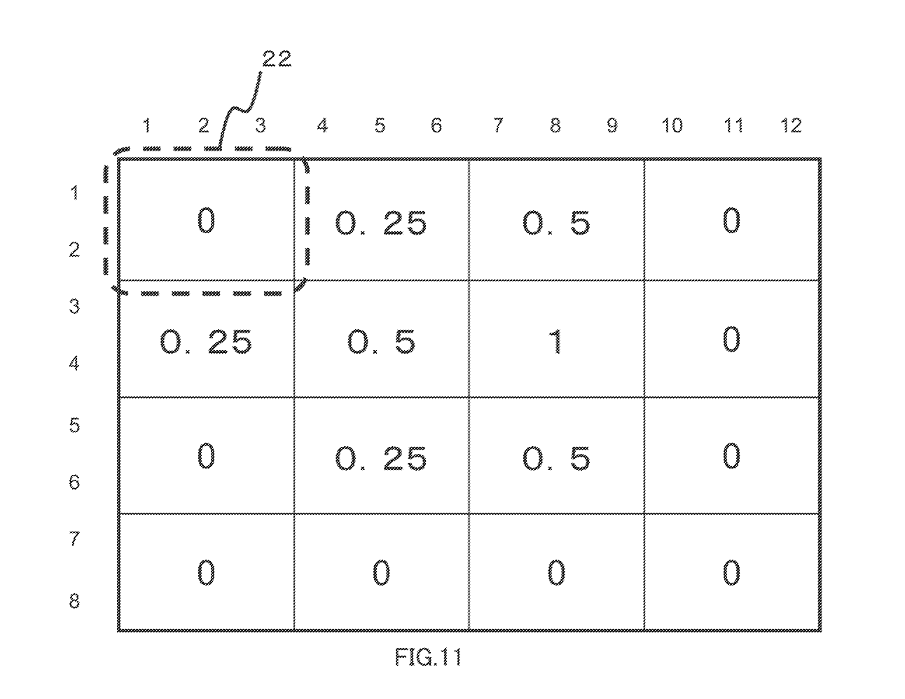

FIG. 11 is a drawing showing luminance signals generated based on the image signal shown in FIG. 9.

The luminance signals shown in FIG. 11 are input to backlight driver 30, and light emission control signals are generated based on these luminance signals. Then light sources 21 in backlight section 20 are driven based on the generated light emission control signals, and backlight section 20 emits light.

<1-2-2. Image Signal Correction Operation>

First, a luminance signal generated by backlight control section 41 is input to block memory control section 421.

Then block memory control section 421 performs control so as to store an input luminance signal temporarily.

Also, when luminance signal storage is completed, block memory control section 421 outputs position coordinates of virtual light source 23 stored in block memory 422 to distance calculation section 423.

Next, distance calculation section 423 calculates distance information D for a distance between relevant virtual light source 23 and a pixel of interest, based on virtual light source 23 position coordinates and position coordinates of a pixel of interest. In this embodiment, virtual light source 23 position coordinates are set based on row and column numbers, so that, for example, the position coordinates of L(1,1) are set as (L(1,1)x,L(1,1)y)=(1.5,1). For a pixel with coordinates (2.5,0.5) located in the row-3/column-1 area, distance information D indicating the distance from virtual light source L(1,1) with the above coordinates is 1.12. Calculated distance information D is output to luminance calculation section 424. This distance information D is assumed to he calculated for all the pixels with which liquid crystal panel 10 is provided.

Luminance calculation section 424 generates an estimated light emission luminance signal from distance information D output from distance calculation section 423.

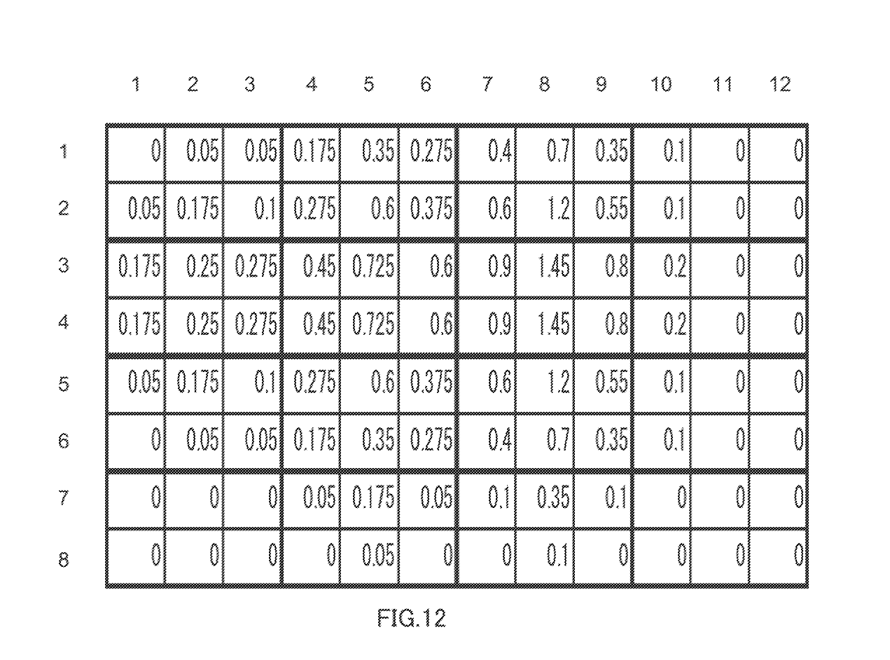

FIG. 12 is a drawing showing an estimated light emission luminance value of each pixel based on distance information D input from distance calculation section 423. When the luminance signals shown in FIG. 11 are input, the estimated light emission luminance values shown in FIG. 12 are calculated for the respective pixels. Normalized luminance information N generated in the course of processing by luminance calculation section 424 is assumed to be indicated in a previously set luminance profile 4241 LUT to be 0.9 when distance information D is 1.12. Luminance calculation section 424 inputs an estimated light emission luminance value to signal correction section 43.

Signal correction section 43 performs gamma conversion of an input estimated light emission luminance value, and inputs a signal that has undergone gamma conversion to image correction section 44.

Image correction section 44 generates transmissivity of a pixel in liquid crystal panel 10 based on an input estimated light emission luminance value.

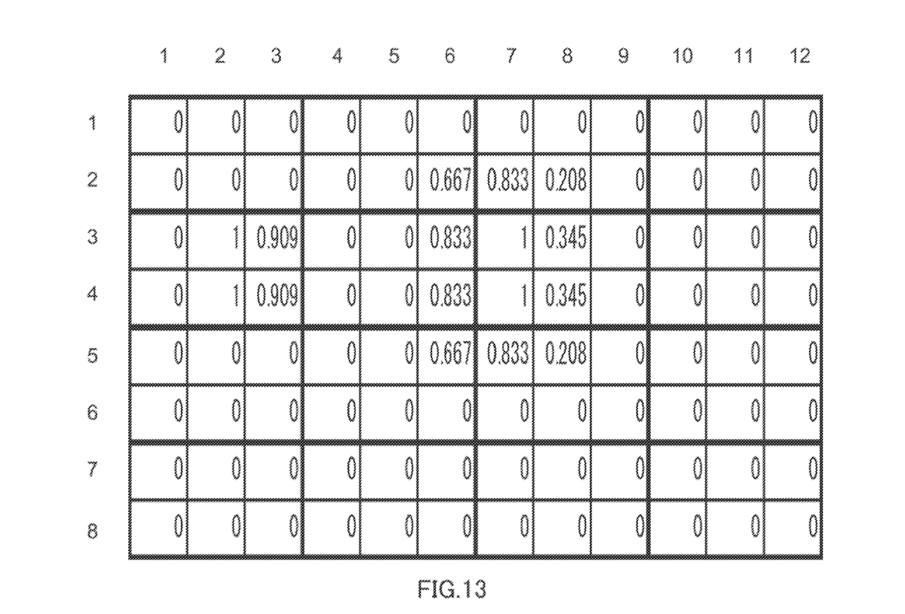

FIG. 13 is a drawing showing transmissivities generated by image correction section 44. As shown in FIG. 13, since light emission luminance differs for each light emission area 22, even if display luminance values included in an image signal are identical, transmissivities of pixels in liquid crystal panel 10 are different values.

Since light emission transmissivity cannot strictly be made 0, a value such as 0. 001, 0.0001, or the like is acquired where 0 is shown, depending on the performance of liquid crystal panel 10.

<1-3. Summary>

As described above, according to this embodiment, based on a luminance signal output from backlight control section 41 and distance information D indicating the distance between a pixel in liquid crystal panel 10 and virtual light source 23 set within light emission area 22, a luminance value of light arriving at that pixel is estimated. In other words, estimation of the luminance value of light arriving at a pixel is performed taking account of the distance between that pixel and virtual light source 23. It is therefore possible to estimate accurately the luminance value of light arriving at that pixel. By this means, suitable transmissivity can be set for each pixel when correcting input image signal display luminance, making it possible to display a higher-quality image than with a conventional liquid crystal display apparatus even when backlight section 20 light emission is controlled on an area-by-area basis.

As described above, a distance taken into account in luminance value estimation for light arriving at a pixel is not a distance from a placed light source 21 itself, but a distance from a reference position, one of which is set for a plurality of light sources 21. Thus, the processing load for distance calculation can be reduced, enabling a reduction in power consumption to be achieved. Furthermore, such a reference position is set for each light emission area 22 formed as a light emission luminance value control unit. In one light emission area 22, one virtual light source 23 can be assumed from a plurality of light sources 21 arranged so as to form that light emission area 22, and one light emission characteristic can easily be stipulated for that virtual light source 23. Therefore, the above estimation can be performed accurately even when using a distance from a light emission area 22 reference position—that is, a virtual light source 23 placement position—instead of a distance from light source 21 itself.

### Embodiment 2

Embodiment 2 of the present invention will now be described. The luminance estimation section described in <1-1-4-2> is characterized by calculating an estimated light emission luminance value using a one-dimensional LUT configuration indicating the relationship between distance information D and normalized luminance value N based on distance information D indicating the distance between virtual light source 23 and a pixel of interest. However, when a one-dimensional LUT is used, it is only possible to represent accurately a light emission characteristic of a one-dimensional linear direction such as the horizontal direction or vertical direction shown in FIG. 5, for example. That is to say, if distance information D for the distance between a pixel of interest and virtual light source 23 is the same, the same normalized luminance value N is calculated even though the light emission characteristics differ.

Thus, in this embodiment, a method is described whereby normalized luminance value N close to an actual virtual light source 23 light emission characteristic is calculated by correcting distance information D using the angle of a line connecting a pixel of interest to virtual light source 23.

Differences from a liquid crystal display apparatus according to Embodiment 1 are that angle information, in addition to distance information D, is included in a signal output from the distance calculation section, and that the distance estimation section is provided with a distance correction section. Otherwise, the configuration is the same.

A liquid crystal display apparatus according to this embodiment will now be described with reference to the accompanying drawings, focusing on the above differences.

<2-1. Luminance Estimation Section>

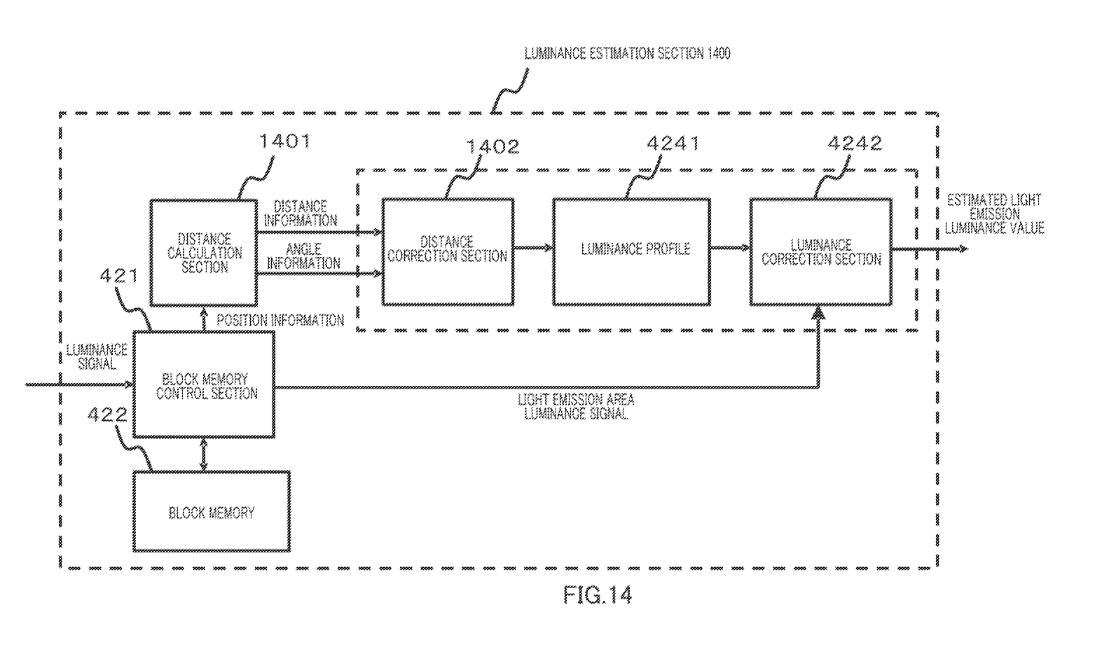

FIG. 14 is a schematic diagram showing the configuration of luminance estimation section 1400 according to this embodiment.

Luminance estimation section 1400 differs from luminance estimation section 42 according to Embodiment 1 in being newly provided with distance correction section 1402, and in that angle information is output from distance calculation section 1401. Configuration elements identical to those in Embodiment 1 are assigned the same reference numbers as in Embodiment 1 and detailed descriptions thereof are omitted here.

<2-1-1. Distance Calculation Section>

Distance calculation section 1401 generates distance information indicating distances between a pixel of interest and each virtual light source 23 in liquid crystal panel 10. Furthermore, distance calculation section 1401 calculates angle information indicating an angle formed by a straight line connecting that pixel of interest to virtual light source 23 and a horizontal straight line passing through virtual light source 23.

Here, distance calculation section 1401 has a configuration whereby, for each pixel of interest, distance information D with respect to all virtual light sources 23 set in backlight section 20 is calculated, and angle information θ with respect to all virtual light sources 23 set in backlight section 20 is calculated. A description of angle information θ calculation is given below. A description of distance information D calculation is omitted here.

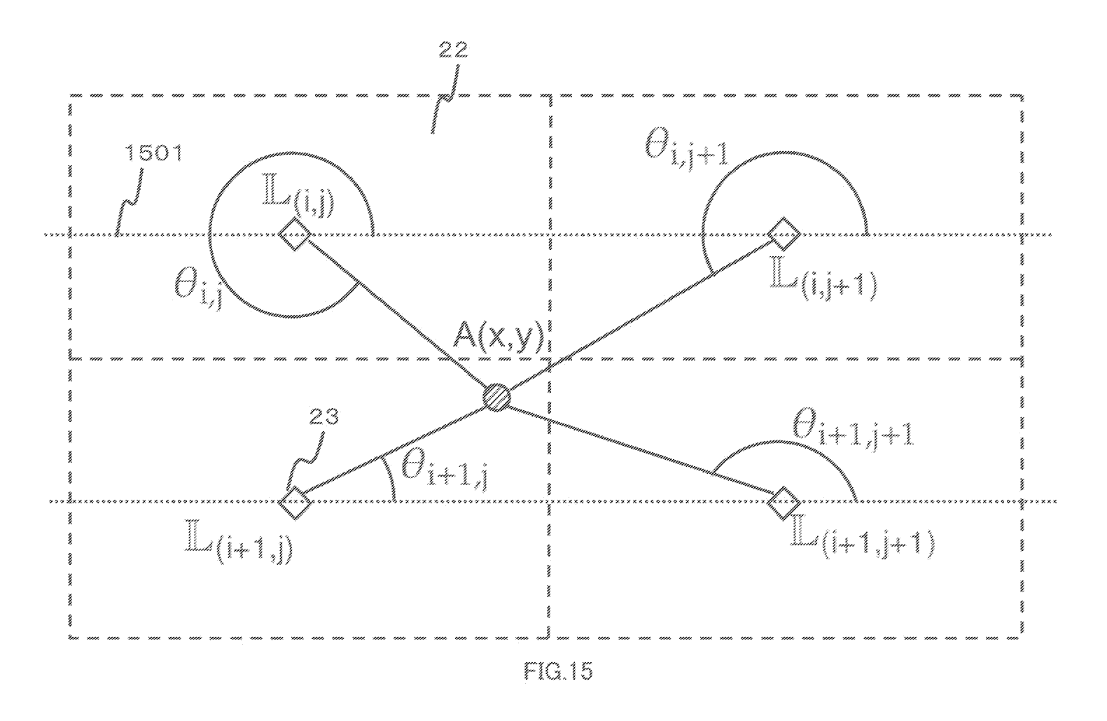

FIG. 15 is a drawing for explaining angle information θ calculation by distance calculation section 1401.

For example, consider finding angle information θ_{i,j} for pixel A and virtual light source L(i,j). The position coordinates of pixel A can be acquired as (x,y). Here, angle information θ_{i,j} is assumed to be set as an angle formed in a counterclockwise direction with respect to horizontal straight line 1501 passing through virtual light source 23.

In this case, angle information can be calculated by means of equation 8.

$${θ}_{i , j} = {tan}^{- 1} ( \frac{( y - {L}_{i , jy} )}{( x - {L}_{i , jx} )} ) \qquad [ 8 ]$$

Distance calculation section 1401 calculates angles for all 16 virtual light sources L(1,1) . . . , L(4,4) set in backlight section 20, and outputs angle information θ represented in the form of equation 9 to distance correction section 1402, together with distance information D. In the above description, only angle information D for pixel A has been described, but the same kind of angle information calculation is performed for all pixels in liquid crystal panel 10. That is to say, if liquid crystal panel 10 has 2 million pixels, 2 million sets of angle information θ represented in the form of equation 9 are output to distance correction section 1402.

$$Θ = [ \begin{matrix}{θ}_{1 , 1} & {θ}_{1 , 2} & … & {θ}_{1 , 4} \\ {θ}_{2 , 1} & {θ}_{2 , 2} & … & {θ}_{2 , 4} \\ ⋮ & ⋮ & ⋱ & ⋮ \\ {θ}_{4 , 1} & {θ}_{4 , 2} & … & {θ}_{4 , 4}\end{matrix} ] \qquad [ 9 ]$$

In this embodiment, when generating angle information θ for pixels of interest and virtual light sources 23. a configuration is assumed whereby angles with respect to all virtual light sources 23 are found, but provision may also be made, for example, for only angles with respect to n (where n is a positive integer) nearby virtual light sources 23 to be found, or for only the angle with respect to the nearest single virtual light source 23 to be found. Also, angle information θ may be represented using a trigonometric function approximation. Furthermore, the format of angle information θ output from distance calculation section 1401 to distance correction section 1402 is not limited to that represented by equation 9.

<2-1-2. Distance Correction Section>

Distance correction section 1402 corrects distance information D input from distance calculation section 1401 based on angle information θ input from distance calculation section 1401.

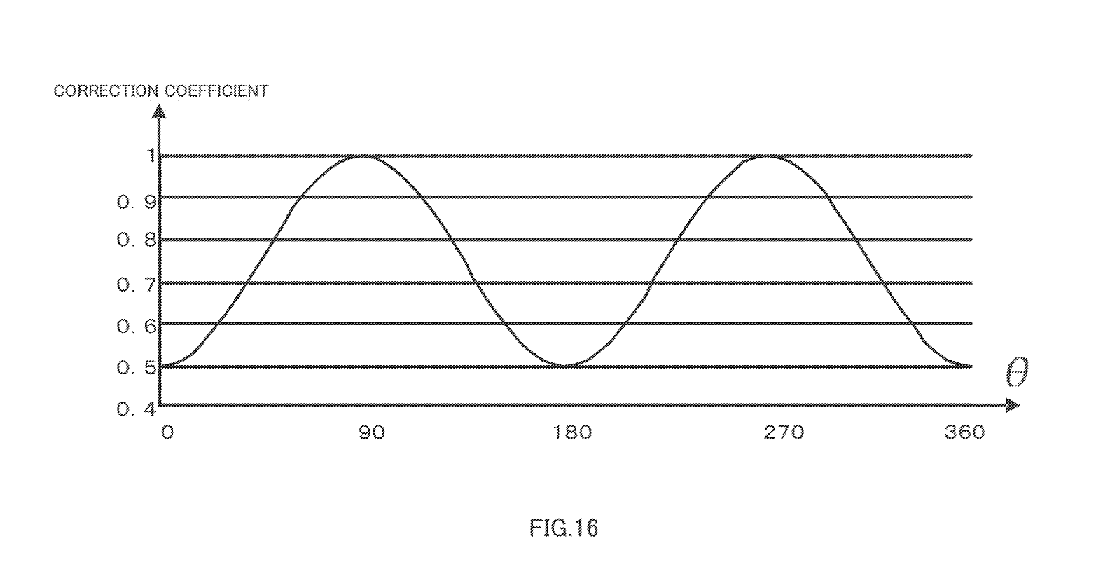

FIG. 16 is a drawing showing the relationship between angle information θ and a distance information D correction coefficient. Here, a correction coefficient is a correction value used when correcting distance information D.

For example, the arrangement of light sources 21 in light emission area 22 is 4×2. That is to say, when a relatively large number of light sources 21 are arranged in the horizontal direction, a virtual light source 23 light emission characteristic has a tendency to be distributed widely in the horizontal direction. Consequently, when light sources 21 are arranged as described above, a correction coefficient is set so as to shorten distance information D in the horizontal direction.

Specifically, when the relationship between angle information θ and a correction coefficient shown in FIG. 16 is set as function f, distance information D is corrected as shown in equation 10.

\tilde{D}_{i,j}=D_{i,j}f(θ_{i,j})

where \tilde{D}_{i,j} is distance information after correction.

For example, if angle information θ for pixel A is 0° and distance information D is 1, post-correction distance information is 0.5. Distance correction section 1402 performs the above correction for each pixel included in distance information D.

The relationship shown in FIG. 16 indicates a characteristic when 4×2 light sources 21 are arranged in light emission area 22, and the characteristic varies according to the degree of diffusion of light of each light source 21, the arrangement method of light sources 21, and the number of light sources 21 included in light emission area 22.

<2-1-3. Luminance Profile>

Post-correction distance information D is output to luminance profile 4241. Luminance profile 4241 calculates normalized luminance value N using input post-correction distance information D.

<2-2. Summary>

By means of the above, it is possible to correct distance information D appropriately based on an angle formed by virtual light source 23 and a pixel even when a light emission area 22 light emission characteristic varies according to various conditions, making it possible to calculate normalized luminance value N more appropriately.

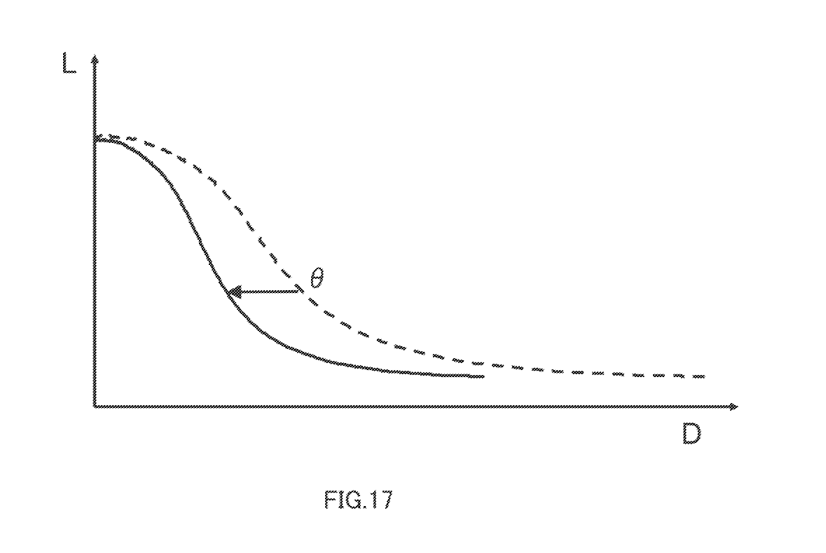

Distance correction section 1402 may also have a configuration whereby a luminance profile in luminance profile 4241 (that is, a light emission characteristic stipulated by luminance profile 4241) is corrected based on angle information θ. Specifically, a luminance profile is corrected so as to be extended or compressed in the horizontal direction by means of angle information θ as shown in FIG. 17. The configuration is such that when a luminance profile is corrected, distance information D output from distance correction section 1402 is not corrected but is output as it is to luminance profile 4241.

### Embodiment 3

Embodiment 3 of the present invention will now be described. The luminance estimation sections described in <1-1-4-2> and <2-1> are characterized by focusing on a distance between a pixel of interest and virtual light source 23, and calculating an estimated light emission luminance value based on a one-dimensional LUT set in the horizontal direction or the vertical direction shown in FIG. 5. However, as described in <2-1>, if the arrangement of light sources 21 in light emission area 22 is spread out in the horizontal direction or the vertical direction, a difference in the light emission characteristic occurs between the horizontal direction and the vertical direction, and it is difficult to represent a light emission area 22 light emission characteristic appropriately by means of one LUT.

Thus, in this embodiment, a method is described whereby separate one-dimensional LUTs are provided for the horizontal direction and the vertical direction, and a normalized luminance value is calculated from those two one-dimensional LUTs based on a horizontal distance and vertical distance between a pixel of interest and virtual light source 23.

The difference from a liquid crystal display apparatus according to Embodiment 1 is that horizontal distance information and vertical distance information for a pixel of interest and virtual light source 23 are output from the distance calculation section. In addition, the configuration whereby the luminance estimation section calculates an estimated light emission luminance value using a horizontal luminance profile and vertical luminance profile differs.

A liquid crystal display apparatus according to this embodiment will now be described with reference to the accompanying drawings, focusing on the above differences.

<3-1. Distance Calculation Section (not shown)>

The distance calculation section calculates a horizontal distance and vertical distance between a pixel of interest and each virtual light source. Here, a horizontal distance is an absolute difference value between an x-coordinate of a pixel of interest and an x-coordinate of virtual light source 23, and a vertical distance is an absolute difference value between a y-coordinate of a pixel and a y-coordinate of virtual light source 23.

When the position coordinates of pixel A are (x,y), a distance calculation section according to this embodiment calculates horizontal distance information Dx and vertical distance information Dy as shown in equation 11.

$${D}_{x} = [ \begin{matrix}{D}_{1 , 1 x} & {D}_{1 , 2 x} & … & {D}_{1 , 4 x} \\ {D}_{2 , 1 x} & {D}_{2 , 2 x} & … & {D}_{2 , 4 x} \\ ⋮ & ⋮ & ⋱ & ⋮ \\ {D}_{4 , 1 x} & {D}_{4 , 2 x} & … & {D}_{4 , 4 x}\end{matrix} ] \\ {𝔻}_{y} = [ \begin{matrix}{D}_{1 , 1 y} & {D}_{1 , 2 y} & … & {D}_{1 , 4 y} \\ {D}_{2 , 1 y} & {D}_{2 , 2 y} & … & {D}_{2 , 4 y} \\ ⋮ & ⋮ & ⋱ & ⋮ \\ {D}_{4 , 1 y} & {D}_{4 , 2 y} & … & {D}_{4 , 4 y}\end{matrix} ] \qquad [ 11 ]$$

where

D_{i,jx}=|x−L_{i,jx}|

and

D_{i,jy}=|y−L_{i,jy}|

Of generated distance information D, the distance calculation section outputs horizontal distance information Dx to a horizontal luminance profile, and outputs vertical distance information Dy to a vertical luminance profile.

<3-2. Luminance Estimation Section>

Luminance estimation section 1800 calculates estimated light emission luminance value N based on horizontal distance information Dx and vertical distance information Dy input from the distance calculation section.

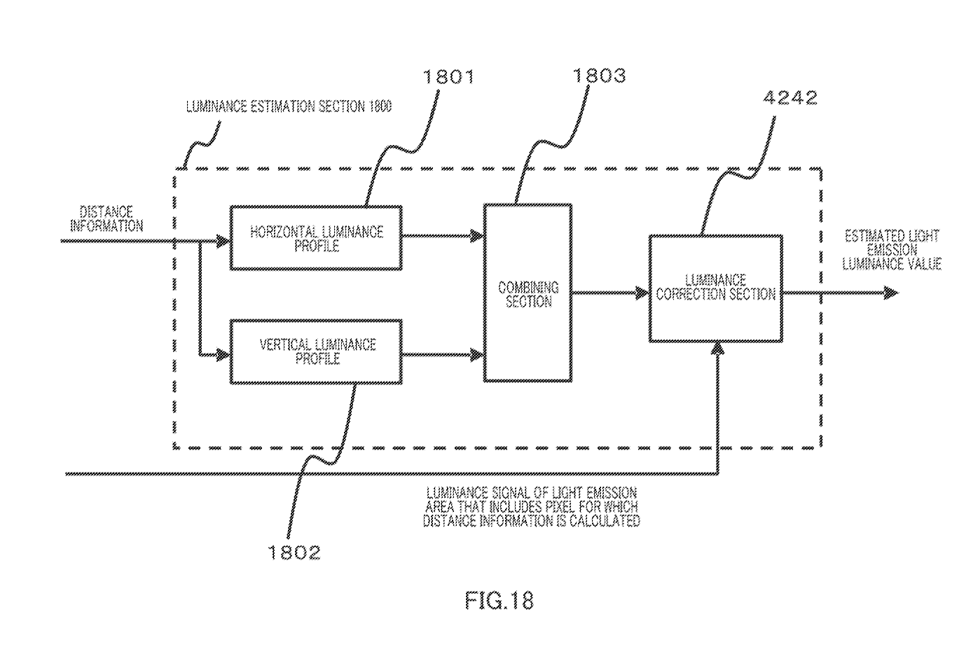

FIG. 18 is a schematic diagram showing the configuration of luminance estimation section 1800 according to this embodiment. Luminance estimation section 1800 has horizontal luminance profile 1801, vertical luminance profile 1802, combining section 1803, and luminance correction section 4242.

<3-2-1. Horizontal Luminance Profile>

Horizontal luminance profile 1801 calculates horizontal normalized luminance value Nx for a pixel of interest based on horizontal distance information Dx input for that pixel of interest. Horizontal normalized luminance value Nx is represented by equation 12. Furthermore, horizontal luminance profile 1801 outputs calculated horizontal normalized luminance value Nx to combining section 1803. Horizontal normalized luminance value Nx is a value indicating horizontal-direction luminescence when light emission is performed at 100% luminescence for virtual light source 23, and is a value that varies within a range of 0 to 1 according to the horizontal distance from virtual light source 23.

$${ℕ}_{x} = [ \begin{matrix}{N}_{1 , 1 x} & {N}_{1 , 2 x} & … & {N}_{1 , 4 x} \\ {N}_{2 , 1 x} & {N}_{2 , 2 x} & … & {N}_{2 , 4 x} \\ ⋮ & ⋮ & ⋱ & ⋮ \\ {N}_{4 , 1 x} & {N}_{4 , 2 x} & … & {N}_{4 , 4 x}\end{matrix} ] \qquad [ 12 ]$$

The calculation of horizontal normalized luminance value Nx will now be described.

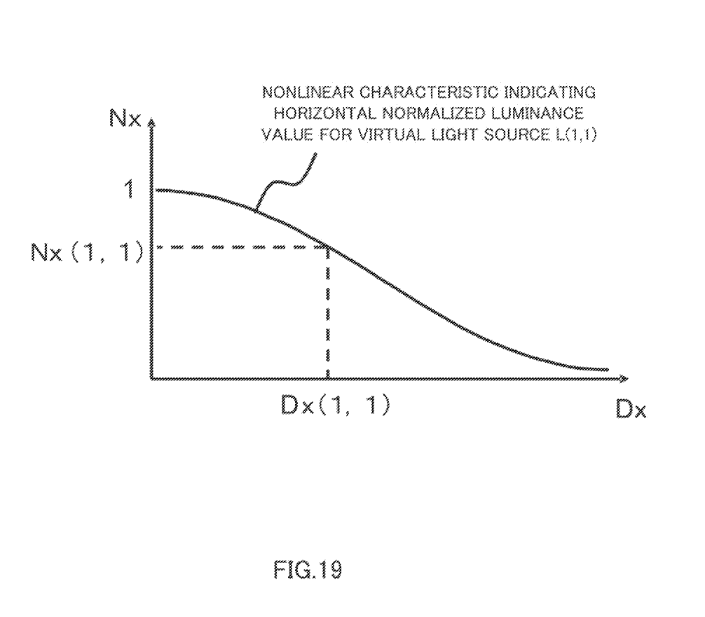

FIG. 19 is a drawing showing a horizontal-direction light emission characteristic of virtual light source 23.

Horizontal normalized luminance value Nx of each virtual light source 23 varies according to the degree of diffusion of light of each light source 21, the arrangement method of light sources 21, and the number of light sources 21 included in light emission area 22. For example, the characteristic shown in FIG. 19 shows that the normalized luminance value varies gently according to the distance from virtual light source L(1,1). In other words, a particular feature of this light emission characteristic is that light spreads out in the horizontal direction. This is due to the fact that light sources 21 are arranged so as to be spread out in the horizontal direction.

Horizontal luminance profile 1801 has the kind of light emission characteristic shown in FIG. 19 as a one-dimensional LUT. In the LUT, for example, horizontal normalized luminance value Nx derived by means of a nonlinear function having horizontal distance information Dx such as shown in FIG. 19 as an argument is stipulated. In this case, in order to find horizontal normalized luminance value Nx(1,1) for a certain pixel, an LUT set for virtual light source L(1,1) is used to find horizontal normalized luminance value Nx(1,1) from horizontal distance information Dx(1,1) for that pixel and virtual light source L(1,1). Horizontal luminance profile 1801 calculates horizontal distance information Dx for a pixel for all 16 virtual light sources. That is to say, horizontal luminance profile 1801 finds 16 horizontal normalized luminance values (Nx(1,1) to Nx(4,4)) for one pixel.

<3-2-2. Vertical Luminance Profile>

Vertical luminance profile 1802 calculates vertical normalized luminance value Ny for a pixel of interest based on vertical distance information Dy input for that pixel of interest. Vertical normalized luminance value Ny is represented by equation 13. Furthermore, vertical luminance profile 1802 outputs calculated vertical normalized luminance value Ny to combining section 1803. Vertical normalized luminance value Ny is a value indicating vertical-direction luminescence when light emission is performed at 100% luminescence for virtual light source 23, and is a value that varies within a range of 0 to 1 according to the vertical distance from virtual light source 23.

$${ℕ}_{y} = [ \begin{matrix}{N}_{1 , 1 y} & {N}_{1 , 2 y} & … & {N}_{1 , 4 y} \\ {N}_{2 , 1 y} & {N}_{2 , 2 y} & … & {N}_{2 , 4 y} \\ ⋮ & ⋮ & ⋱ & ⋮ \\ {N}_{4 , 1 y} & {N}_{4 , 2 y} & … & {N}_{4 , 4 y}\end{matrix} ] \qquad [ 13 ]$$

The calculation of vertical normalized luminance value Ny will now be described.

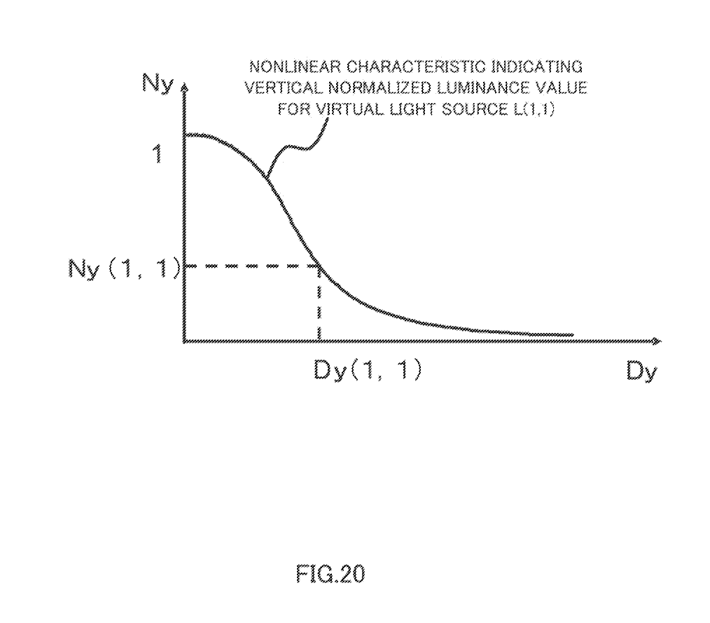

FIG. 20 is a drawing showing a vertical-direction light emission characteristic of virtual light source 23.

Vertical normalized luminance value Ny of each virtual light source 23 varies according to the degree of diffusion of light of each light source 21, the arrangement method of light sources 21, and the number of light sources 21 included in light emission area 22. For example, the characteristic shown in FIG. 20 shows that the rate of change of normalized luminance value Ny based on the distance from virtual light source L(1,1) is steeper than that of horizontal normalized luminance value Nx. In other words, a feature of this light emission characteristic is that light does not spread out in the vertical direction as compared with the horizontal direction. This is due to the fact that light sources 21 are arranged so as to be spread out in the horizontal direction in a light emission area.

Vertical luminance profile 1802 has the kind of light emission characteristic shown in FIG. 20 as a one-dimensional LUT. In the LUT, for example, vertical normalized luminance value Ny derived by means of a nonlinear function having vertical distance information Dy such as shown in FIG. 20 as an argument is stipulated. In this case, in order to find vertical normalized luminance value Ny(1,1) for a certain pixel, an LUT set for virtual light source L(1,1) is used to find vertical normalized luminance value Ny(1,1) from vertical distance information Dy(1,1) for that pixel and virtual light source L(1,1). Vertical luminance profile 1802 calculates vertical distance information Dy for a pixel for all 16 virtual light sources. That is to say, vertical luminance profile 1802 finds 16 vertical normalized luminance values (Ny(1,1) to Ny(4,4)) for one pixel.

<3-2-3. Combining Section>

Combining section 1803 combines horizontal normalized luminance value Nx for a pixel of interest output from horizontal luminance profile 1801 and vertical normalized luminance value Ny for a pixel of interest output from vertical luminance profile 1802, and calculates normalized luminance value N. Furthermore, combining section 1803 outputs calculated normalized luminance value N to luminance correction section 4242.

The actual combining method used by combining section 1803 will now be described.

Combining section 1803 calculates normalized luminance value N shown by equation 14 based on horizontal normalized luminance value Nx and vertical normalized luminance value Ny.

$$ℕ = [ \begin{matrix}min ( {N}_{1 , 1 x} , {N}_{1 , 1 y} ) & min ( {N}_{1 , 2 x} {N}_{1 , 2 y} ) & … & min ( {N}_{1 , 4 x} {N}_{1 , 4 y} ) \\ min ( {N}_{2 , 1 x} , {N}_{2 , 1 y} ) & min ( {N}_{2 , 2 x} , {N}_{2 , 2 y} ) & … & min ( {N}_{2 , 4 x} , {N}_{2 , 4 y} ) \\ ⋮ & ⋮ & ⋱ & ⋮ \\ min ( {N}_{4 , 1 x} {N}_{4 , 1 y} ) & min ( {N}_{4 , 2 x} {N}_{4 , 2 y} ) & … & min ( {N}_{4 , 4 x} , {N}_{4 , 4 y} )\end{matrix} ] \qquad [ 14 ]$$

where the min(α,β) operator is an operator that outputs the smaller of α or β.

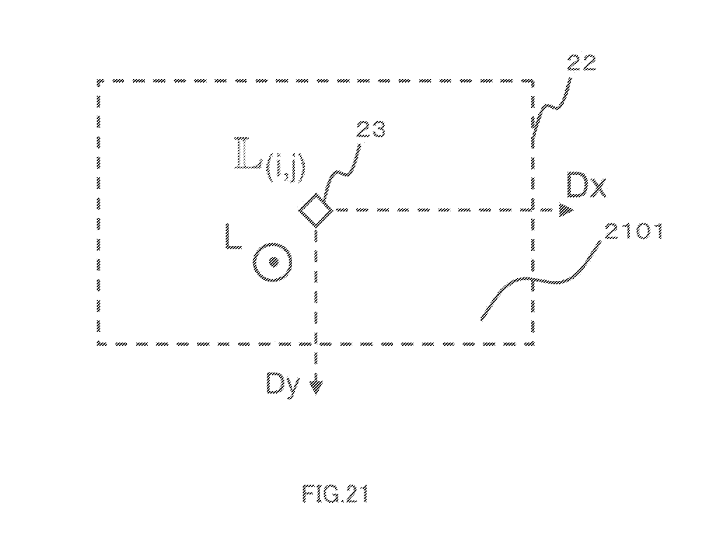

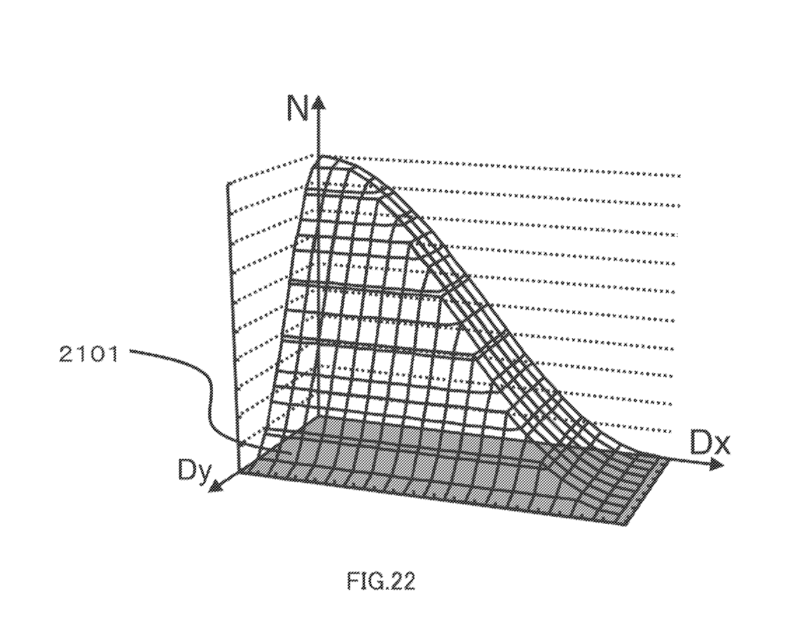

When an estimated light emission luminance value for a pixel within light emission area 22 that includes L(i,j) is calculated based on normalized luminance values N such as described above, this kind of normalized luminance distribution shown in FIG. 22 is created for partial light emission area 2101 shown in FIG. 21.

The estimated light emission luminance value generation method used by combining section 1803 is not limited to the min( ) operator. For example, a configuration may be used whereby a horizontal estimated light emission luminance value and a vertical light emission luminance value are multiplied by different weighting factors, and the post-multiplication values are added together. A weighting factor may be calculated based on an angle formed by a horizontal straight line with virtual light source 23 as its center and a pixel of interest. A weighting factor may also be decided based on the values of position coordinates (x,y) of a pixel of interest.

Normalized luminance value N output from combining section 1803 is input to luminance correction section 4242, where the same kind of processing is performed as in Embodiment 1 of the present invention.

### Embodiment 4

Embodiment 4 of the present invention will now be described. The luminance estimation section described in <1-1-4-2> is characterized by calculating an estimated light emission luminance value using a one-dimensional LUT configuration indicating the relationship between distance information D and normalized luminance value N based on distance information D indicating the distance between virtual light source 23 and a pixel of interest.

Here, the luminance estimation section generates normalized luminance value N for a pixel of interest based on distance information D indicating the distance between virtual light source 23 and the pixel of interest. Consequently, when a circle with virtual light source 23 as its center is considered, all the pixels on the circumference of that circle have the same normalized luminance value.

However, if the arrangement of light sources 21 in light emission area 22 is 4×2—that is, a relatively large number of light sources 21 are arranged in the horizontal direction—virtual light source 23 light emission characteristics differ in the horizontal direction and the vertical direction. Consequently, under specific conditions such as a virtual light source 23 light emission characteristic differing in the horizontal direction and in the vertical direction, an unnatural light emission characteristic will result if normalized luminance values N generated for all pixels on the same circumference are treated as being equal.

Thus, in this embodiment, a light emission characteristic is used whereby normalized luminance values N generated for all pixels on the circumference of the same ellipse become equal.

The difference from a liquid crystal display apparatus according to Embodiment 1 is that the calculation method for distance information D calculated by the distance calculation section is changed to a calculation method using an elliptical characteristic. Otherwise, the configuration is the same.

<4-1. Distance Calculation Section (not shown)>

A distance calculation section according to this embodiment will now be described with reference to the accompanying drawings.

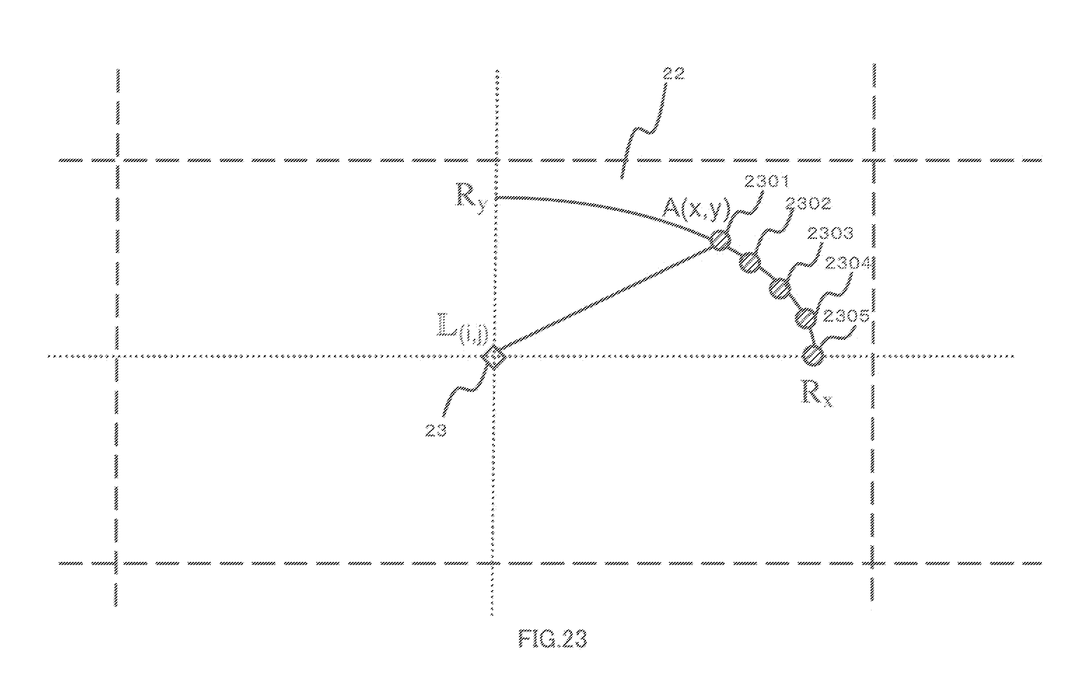

FIG. 23 is a drawing for explaining a method of generating distance information indicating the distance between virtual light source L(i,j) and pixel of interest A(x,y) using an elliptical characteristic. In FIG. 23. light emission area 22 is set as an area that spreads out in the horizontal direction. Also, it is assumed that an elliptical characteristic is set whereby a long axis radius of length Rx and a short axis radius of length Ry are set as shown in FIG. 23.

In this case, an ellipse equation representing an ellipse that passes through long axis endpoint Rx and short axis endpoint Ry can be represented by equation 15.

$${( \frac{x}{{R}_{x}} )}^{2} + {( \frac{y}{{R}_{y}} )}^{2} = 1 \qquad [ 15 ]$$

Rx and Ry in equation 15 have the relationship shown in equation 16.

$$k = \frac{{R}_{x}}{{R}_{y}} \qquad [ 16 ]$$

Here, k shown in equation 16 is called ellipticity, and is a value that varies according to the degree of diffusion of light of each light source 21, the arrangement method of light sources 21, and the number of light sources 21 included in light emission area 22, and that is set beforehand. For example, if light source 21 arrangement differs in the horizontal direction and in the vertical direction so that backlight luminance becomes uniform over the entire screen by making light diffusion lenses attached to light sources 21 anisotropic, the value of k is set in line with light source 21 luminance distribution anisotropy. The value of k may also be set based on the ratio of the horizontal direction to the vertical direction of light emission area 22.

If the relationship between distance information and normalized luminance value N has been set centered on the horizontal direction in luminance profile 4241, the distance calculation section outputs Rx as distance information by using equation 15 and equation 16. If the relationship between distance information and normalized luminance value N has been set centered on the vertical direction in luminance profile 4241, the distance calculation section outputs Ry as distance information by using equation 15 and equation 16. As shown in FIG. 23, the same value (for example, Rx) is output as distance information for all of pixels 2301, 2302, 2303, 2304, and 2305 on the same ellipse, and therefore the same normalized luminance value N is acquired for all of them. Pixels on the same ellipse are not limited to the above.

<4-2. Summary>

By using the above configuration, it is possible to generate an estimated light emission luminance value for a pixel even when the light emission characteristic differs in the horizontal direction and in the vertical direction, such as when different numbers of light sources 21 are arranged in the horizontal direction and in the vertical direction within light emission area 22.

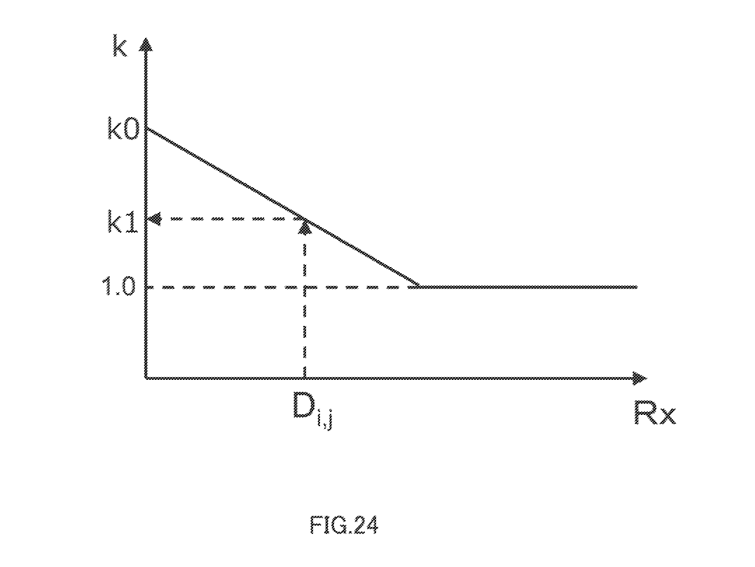

Ellipticity k may also be a value that varies according to the distance between virtual light source 23 and a pixel. Specifically, a configuration is used whereby, as shown in FIG. 24, the ellipticity value approaches I and an ellipse approaches a circle as the distance increases. Using a configuration such as described above makes it possible to generate an estimated light emission luminance value for a pixel more accurately.

### Other Embodiments

Other embodiments are described below.

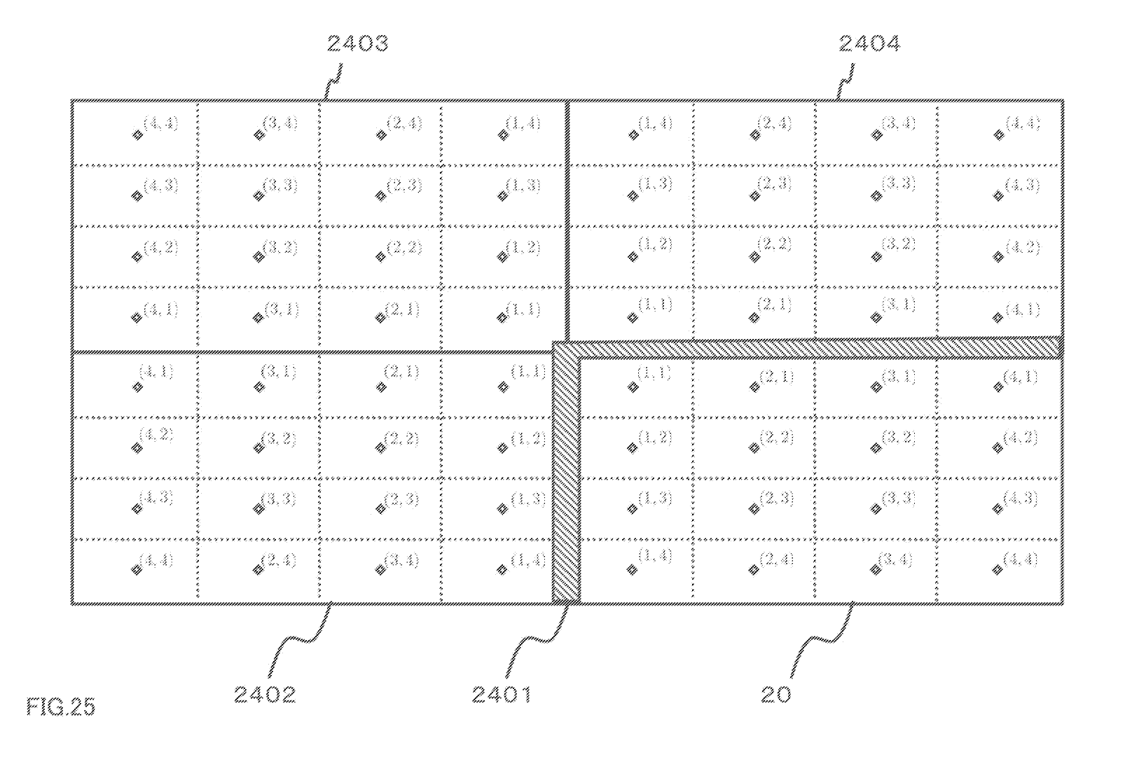

In Embodiments 1 through 4, a configuration may be used that is provided with reflector 2401 that reflects irradiation light from virtual light source 23 to a side area of backlight section 20. FIG. 25 is a drawing showing a configuration in which backlight section 20 is provided with reflector 2401. When reflector 2401 is set on backlight section 20, behavior is shown whereby backlight section 20 is virtually expanded. That is to say, the configuration appears to be provided with virtual backlight sections 2402, 2403, and 2404 around backlight section 20.

For example, when normalized luminance value N is calculated for a pixel in the vicinity of virtual light source L(1,1), if reflector 2401 is not provided, it is only necessary to calculate distance information for the 16 light sources of backlight section 20. However, by attaching reflector 2401. a maximum of eight virtual backlight sections 20 can be considered to be arranged, and therefore a maximum of 128 items of distance information are calculated for one pixel.

By using the above kind of configuration, it is possible to calculate an estimated light emission luminance value for a pixel of interest with greater precision.

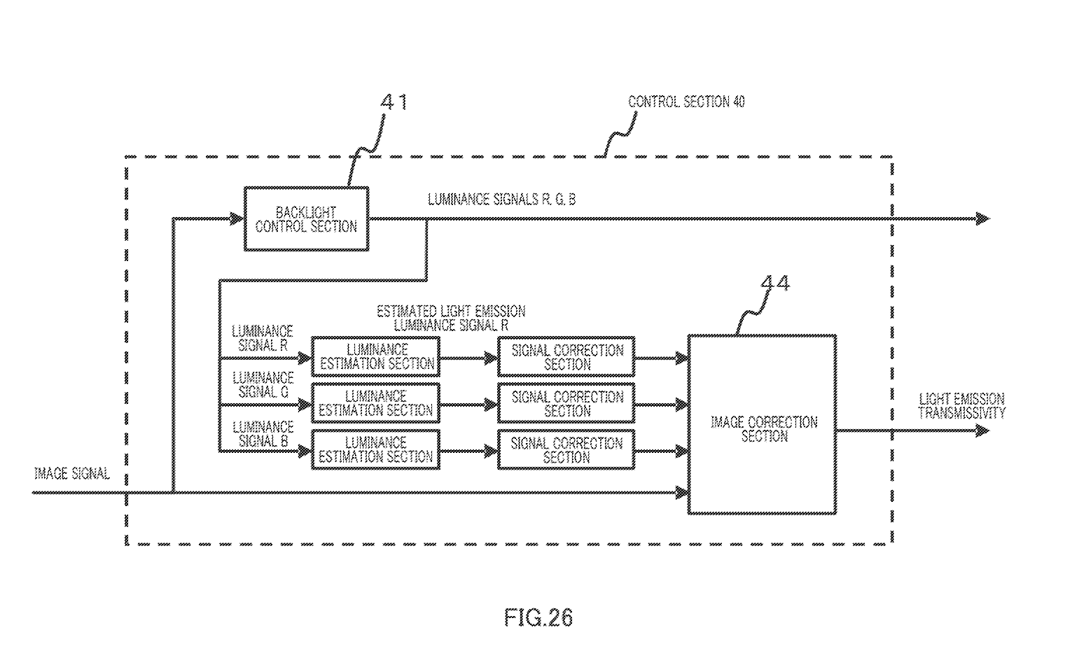

Also, as stated in Embodiment 1, light source 21 may also be a device that emits white light by mixing R, G, and B light, and this also applies to Embodiments 2 through 4. In this case, provision may be made for light emission luminance to be controlled individually for R, G, and B. FIG. 26 is a drawing showing a configuration of a control section of a liquid crystal display apparatus having a backlight that can be controlled independently for R, G, and B. Luminance signals corresponding to R, G, and B respectively are output from backlight control section 41. Three luminance estimation section and signal correction section systems are provided for R, G, and B respectively. By using such a configuration, an estimated light emission luminance value input signal is calculated for each of R, G, and B.

By using the above kind of configuration, it is possible to calculate an estimated light emission luminance value for a pixel of interest with greater precision even when light emission luminance can be controlled independently for R, G, and B.

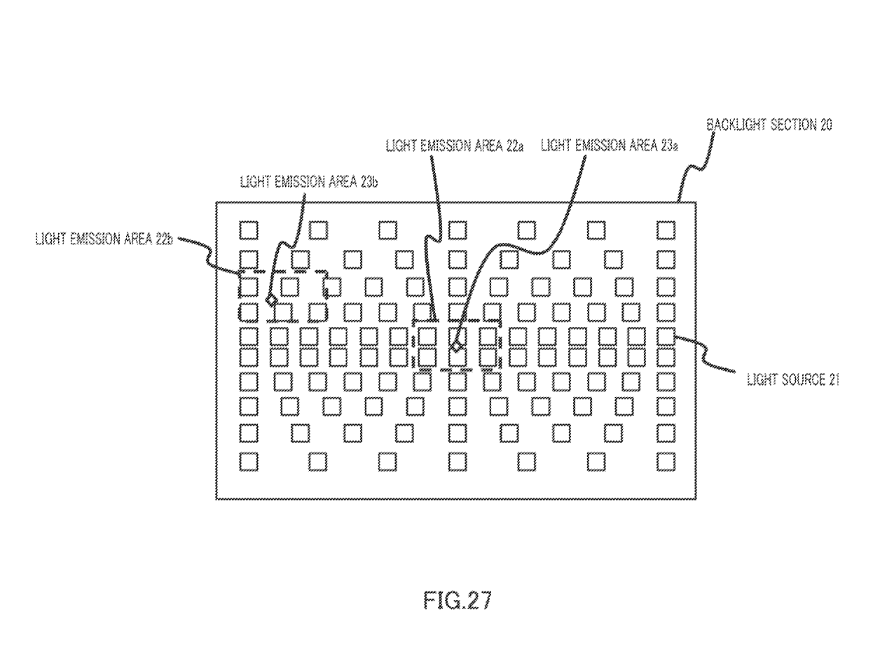

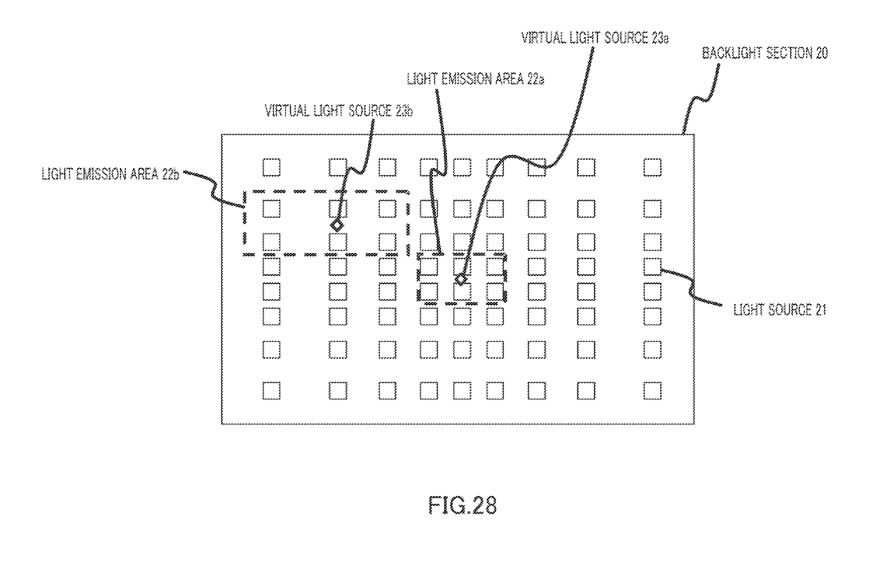

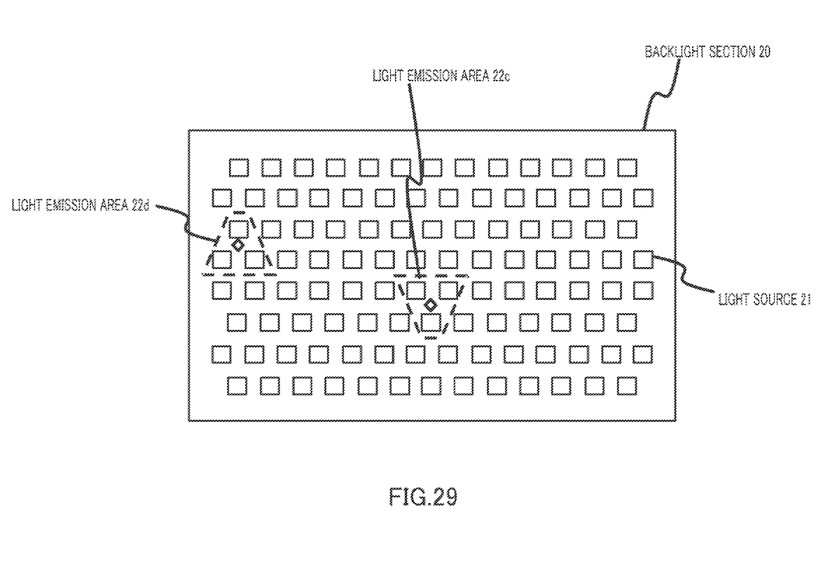

Also, in Embodiments 1 through 4, the description assumes that light sources 21 are arrayed with a uniform pitch, but the present invention can also be applied in the case of a configuration whereby light sources 21 are arrayed with a nonuniform pitch. FIG. 27 and FIG. 28 show examples of unequal pitch arrays. In these examples, light sources 21 are arranged more densely in light emission area 22a in the vicinity of the center of backlight section 20 than in light emission area 22b in the vicinity of the outer periphery. In these cases, the positions of virtual light sources in individual light emission areas may differ in relative terms. Specifically, in light emission area 22a in the vicinity of the center, six light sources 21 are arrayed in a symmetrical fashion, and therefore the position of virtual light source 23a of light emission area 22a is at the center of light emission area 22a. In contrast, in FIG. 27, in light emission area 22b in the vicinity of the outer periphery five light sources 21 are arrayed in an asymmetrical fashion, and therefore the position of virtual light source 23b of light emission area 22b is offset from the center of light emission area 22b. Even if such an asymmetrical pitch array is employed, estimated light emission luminance value generation can still be performed with a high degree of precision if a light emission area light emission characteristic is stipulated for each light emission area as described above. This also applies to a case such as shown in FIG. 29, for example, in which a plurality of light sources 21 forming a plurality of light emission areas (light emission areas 22c, 22d, and so forth) in backlight section 20 are arrayed so as to form delta shapes.

Above Embodiments 1 through 4 may also be used in mutual combination. Also, another embodiment may he used in combination with Embodiments 1 through 4.

The disclosure of Japanese Patent Application No. 2009-156693, filed on Jul. 1, 2009, including the specification, drawings and abstract, is incorporated herein by reference in its entirety.

### INDUSTRIAL APPLICABILITY

An image display apparatus according to the present invention enables a reduction in power consumption to be achieved while displaying a high-quality image, and is therefore suitable for use as a PC monitor, digital TV, or suchlike image display apparatus.

### REFERENCE SIGNS LIST

10 Liquid crystal panel
20 Backlight section
21 Light source
22, 22a through 22d Light emission area
23, 23a, 23b Virtual light source
30 Backlight driver
40 Control section
41 Backlight control section
42, 1400, 1800 Luminance estimation section
43 Signal correction section
44 Image correction section
421 Block memory control section
422 Block memory
423, 1401 Distance calculation section
424 Luminance calculation section
1402 Distance correction section
1501 Straight line
1801 Horizontal luminance profile
1802 Vertical luminance profile
1803 Combining section
2101 Partial light emission area
2301, 2302, 2303, 2304, 2305 Pixel
2401 Reflector
2402, 2403, 2404 Virtual backlight section
4241 Luminance profile
4242 Luminance correction section

1. An image display apparatus comprising:
a light source section including a plurality of light sources arranged so that a plurality of light emission areas are formed;
a display section that displays an image by modulating light from the light source section in accordance with a modulation coefficient corresponding to an input image signal;
a light source control section that controls a light emission luminance value of the light source section for each light emission area; and
a control section that controls the image display apparatus.
wherein the control section. based on distance information indicating a distance between a pixel of the display section and a reference position in each of one or more light emission areas, a luminance value of light arriving at the pixel decided based on a controlled light emission luminance value, and an input image signal of the pixel, calculates the modulation coefficient corresponding to an input image signal of the pixel.

2. The image display apparatus according to claim 1, wherein the control section uses a linear distance between two-dimensional coordinates of the pixel on a predetermined surface and two-dimensional coordinates of the reference position as a value of the distance information.

3. The image display apparatus according to claim 1, wherein:
the light source control section generates a luminance signal indicating a light emission luminance value of the light source section for each light emission area; and
the control section acquires a normalized luminance value of the pixel based on the distance information, and decides a luminance value of light arriving at the pixel by correcting an acquired normalized luminance value based on the generated luminance signal.

4. The image display apparatus according to claim 3, wherein:
the control section uses a function that derives a normalized luminance value from distance information indicating a distance between the pixel and a reference position in a specific light emission area to acquire a normalized luminance value of the specific light emission area; and
the function is set for each light emission area.

5. The image display apparatus according to claim 1, wherein the control section decides a luminance value of light arriving at the pixel while performing adjustment according to the fact that spreading of light from the reference position is nonuniform.

6. The image display apparatus according to claim 3, wherein:
the distance information includes horizontal distance information and vertical distance information; and
the control section acquires the normalized luminance value of the pixel based on the distance information by combining a collection of normalized luminance values of each light emission area based on the horizontal distance information and a collection of normalized luminance values of each light emission area based on the vertical distance information.

7. The image display apparatus according to claim 6, wherein:
the control section uses a function that derives a normalized luminance value from distance information indicating a distance between the pixel and a reference position in a specific light emission area to acquire a normalized luminance value of the specific light emission area; and
the function is set for each light emission area and for each of a horizontal direction and a vertical direction.

8. The image display apparatus according to claim 1,
wherein the control section corrects the distance information based on an angle of a line connecting the pixel and the reference position in order to be used in deciding a luminance value of light arriving at the pixel.

9. The image display apparatus according to claim 8,
wherein the control section, when an angle of a line connecting the pixel and a specific reference position corresponds to a direction in which spreading of light from the specific reference position is relatively greater, makes distance information indicating a distance between the pixel and the specific reference position relatively shorter.

10. The image display apparatus according to claim 1,
wherein the control section makes the distance information an identical value for all pixels positioned on a line of equal luminance set based on spreading of light from a specific reference position.

11. The image display apparatus according to claim 10,
wherein a general form of the line of equal luminance is elliptical at a position near the specific reference position, and is circular at a position far from the specific reference position.

12. The image display apparatus according to claim 10,
wherein a general form of the line of equal luminance approaches circular from elliptical as distance increases from the specific reference position.

13. A control apparatus that performs control of an image display apparatus that displays an image by modulating, in accordance with a modulation coefficient corresponding to an input image signal, light from a light source section that includes a plurality of light sources arranged so that a plurality of light emission areas are formed and for which a light emission luminance value is controlled for each light emission area, the control apparatus comprising a control section that, based on distance information indicating a distance between a pixel and a reference position in each of one or more light emission areas, a luminance value of light arriving at the pixel decided based on a controlled light emission luminance value, and an input image signal of the pixel, calculates the modulation coefficient corresponding to an input image signal of the pixel.

14. An integrated circuit that performs control of a liquid crystal display apparatus, wherein:
the liquid crystal display apparatus has:
a light source section including a plurality of light sources arranged so that a plurality of light emission areas are formed; and
a display section that displays an image by modulating light from the light source section in accordance with a modulation coefficient corresponding to an input image signal;
the integrated circuit has:
a light source control section that controls a light emission luminance value of the light source section for each light emission area; and
a control section that controls the display apparatus; and
the control section, based on distance information indicating a distance between a pixel of the display section and a reference position in each of one or more light emission areas, a luminance value of light arriving at the pixel decided based on a controlled light emission luminance value, and an input image signal of the pixel, calculates the modulation coefficient corresponding to an input image signal of the pixel.
